(19) United States
(12) Patent Application Publication
(10) Pub. No.: US 2020/0407508 A1
(43) Pub. Date: Dec. 31, 2020

(54) METHOD FOR PRODUCING FIBERS, FILMS AND MOLDINGS OF A POLYBENZAZOLE POLYMER (P)

(71) Applicant: BASF SE, Ludwigshafen am Rhein (DE)

(72) Inventors: Marcel BRILL, Ludwigshafen (DE); Ines DEBEAUVAIS DE VASCONCELOS, Ludwigshafen (DE); Maik NOWAK, Ludwigshafen (DE); Olivier FLEISCHEL, Ludwigshafen (DE); Martin MERGER, Ludwigshafen (DE); Achim STAMMER, Ludwigshafen (DE); Joachim RUCH, Ludwigshafen (DE); Frank HERMANUTZ, Denkendorf (DE); Ronald BEYER, Denkendorf (DE); Michael R. BUCHMEISER, Remshalden (DE)

(73) Assignee: BASF SE, Ludwigshafen am Rhein (DE)

(21) Appl. No.: 16/978,948

(22) PCT Filed: Mar. 1, 2019
(86) PCT No.: PCT/EP2019/055092

§ 371 Date: Sep. 8, 2020

(30) Foreign Application Priority Data
Mar. 9, 2018 (EP) 18160970.2

(51) Int. Cl. C08G 73/22; C08J 5/18; C08L 79/04

(52) U.S. Cl. CPC C08G 73/22; C08L 79/04; C08J 5/18

(57) ABSTRACT

A method for producing films, fibers, and moldings of a polybenzazole polymer (P) by reacting at temperatures of 0 to 120° C. a mixture including (a) aromatic dicarboxylic compound(s) (I):

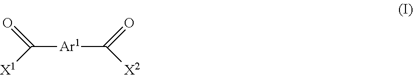

wherein Ar¹ is optionally substituted phenylene, naphthalenediyl, anthracenediyl, biphenyldiyl, diphenylmethanediyl, diphenyl ether diyl, diphenyl thio ether diyl, diphenyl sulfone diyl, benzophenonediyl, pyridinediyl, pyrimidinediyl, furandiyl, or thiophenediyl, substituents being —F, —Cl, —Br, —OR¹, and —C₁-C₁₀-alkyl, R¹ being —H or —C₁-C₁₀-alkyl; X¹ and X² are independently-OR², —F, —Cl, or —Br, R² being —H, —C₁-C₁₀-alkyl, —C₁-C₁₀-alkenyl or a repeating unit (a):

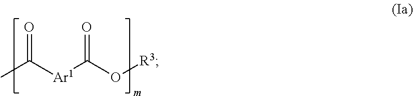

wherein m is a natural number from 1 to 50, and R³ is —H, C₁-C₁₀-alkyl, or C₁-C₁₀-alkenyl; (b) aromatic diamino compound(s) of formula (IIa), (IIb), (IIc) and/or (IId); (c) at least one ionic liquid (IL), to obtain a product, processing the product at temperatures 0 to 100° C. and heating of the articles obtained at temperatures of 250 to 500° C.

The present invention relates to a method for producing fibers, films and moldings of a polybenzazole polymer (P) as defined in the claims. The present invention also relates to fibers, films and moldings obtainable by the method according to the invention and also to the use of the fibers obtainable by the method according to the invention in textiles, to the use of films obtainable by the method according to the invention and to the use of moldings obtainable by the method according to the invention.

Polybenzazole polymers are known and represent a class of organic polymers which are used in particular as high-performance fibers and, owing to their exceptional tensile strength, even exceed glass, ceramic and carbon fibers in terms of their properties. Organic high-performance fibers such as polybenzazole polymers are increasingly used in technically demanding sectors since they are characterized by exceptionally high strengths and moduli of elasticity and by high thermal stability, flame retardance and resistance to chemicals.

In contrast to metallic materials, polymeric materials based on polybenzazole polymers and typically also the corresponding fibers, films and moldings are often prone to degradation processes under natural environmental influences which results in rapid aging and thus deterioration in the properties up to the extent that they are unusable. Due to the effect of external environmental influences such as UV radiation and moisture, rapid degradation generally takes place, whereby ultimately the mechanical properties, and in the case of fiber materials particularly, the tensile strength are significantly diminished. Due to rapid aging, materials based on polybenzazole polymers generally must either be exchanged after a brief time or be protected from environmental influences in an appropriate manner by composite construction with more resistant materials. Although aging can be slowed by sheathing, the low aging resistance prevents universal usability of materials based on polybenzazole polymers to a few special sectors.

The preparation of polybenzazole polymers—for example poly(benzo[1,2-d:4,5′-d″]bisoxazole-2,6-diyl-1,4-phenylene), hereinafter also referred to as “PBO”—is known and is described in the prior art.

For instance, “Kumar et al., Rigid-Rod Polymeric Fibers, Journal of Applied Polymer Science, Vol. 100, 791-802 (2006)” discloses the production of polybenzazole polymers from terephthalic acid and an aromatic diamino compound having two further substituents, wherein the two further substituents can be amino groups, hydroxyl groups or thiol groups.

In a somewhat more general form, but also specifically concerning PBO, David H. Wang, Hao Jiang, W. Wade Adams, are concerned with “Rigid Rod Polymers” in Encyclopedia of Polymer Science and Technology, John Wiley and Sons, Inc., pp. 1 to 88, 2011, also referred to below as “Wang et al.”

The polycondensation of the starting compounds terephthalic acid and aromatic diamino compound having two further substituents, for example to give PBO, usually takes place in the cases described in the literature in the presence of polyphosphoric acid, optionally with addition of diphosphorus pentoxide P₂O₅, which serves simultaneously as solvent, catalyst and dehydrating agent.

A problem of polybenzazole polymers, for example PBO, is that they only dissolve in very few solvents, wherein the solvent of choice both for the reaction to give the polybenzazole polymers, for example PBO, and the further processing to fibers and films for example, is polyphosphoric acid optionally with addition of diphosphorus pentoxide P₂O₅, see Wang et al. p. 15, second paragraph, first to fifth lines.

The use of acids used hitherto—in particular polyphosphoric acid optionally with addition of diphosphorus pentoxide P₂O₅—for the synthesis of polybenzazole polymers, for example PBO, has proved disadvantageous however, since these acids cannot be completely removed from the polybenzazole polymer, for example PBO, after the production process and therefore always remain in low concentrations in the polymer matrix. Under the influence of moisture, these acid residues initiate hydrolysis of the polymer chains, for example of PBO. This degradation is significantly accelerated by the effect of UV.

For instance, “Holmes et al., The Effect of Environmental and Mechanical Mechanisms on the Performance of Soft Body Armor, 2009, Analytical Chemistry Division, ICCM International Conferences on Composite Materials 01/2009”, discloses that the lack of stability to hydrolysis of benzoxazole rings is due to low residual contents of phosphoric acid from the production process of PBO. The phosphoric acid can be present here as free phosphoric acid or in the form of aryl phosphate esters, which are bonded to polybenzoxazole, in which the aryl phosphate esters slowly hydrolyze in the presence of water and form phosphoric acid.

“Chin et al., Temperature and humidity aging of poly(p-phenylene-2,6-benzo-bisoxazole) fibers: Chemical and physical characterization, Polymer Degradation and Stability, 92, 1234-1246 (2007)” discloses that the sensitivity of polybenzoxazole polymers (PBO) to hydrolysis or elevated temperatures is due to polyphosphoric acid residues, which results in opening of the benzoxazole rings and thus to polymer degradation.

CN 103 880 767 describes a method for producing a polybenzazole polymer in polyphosphoric acid. In this case however, in a first step, terephthaloyl dichloride and 4,6-diaminoresorcinol (4,6-diamino-1,3-dihydroxybenzene) are reacted in another solvent, namely in a strongly hydrophobic ionic liquid. This results in a dimeric, i.e. not polymeric reaction product, which has been formed from exactly one molecule of terephthaloyl dichloride and exactly one molecule of 4,6-diaminoresorcinol. To produce the polybenzazole polymer, this condensation product is reacted in a second step in phosphoric acid and phosphorus pentoxide.

The object of the present invention therefore consists of providing an improved preparation process of fibers, films and moldings of polybenzazole polymers, preferably PBO, which can be carried out without the solvents used in the prior art for producing and/or further processing of the polybenzazole polymers, preferably PBO, or in which the solvent, typically after work-up, can be reused. With the improved method, fibers, films and moldings composed of polybenzazole polymers, preferably PBO, can be provided which have improved aging resistance, resistance to hydrolysis and/or better resistance to UV radiation.

This object was achieved by a method for producing fibers, films and moldings of a polybenzazole polymer (P), for example PBO, by reacting a reaction mixture (R_{G}) comprising the following components:

(a) at least one aromatic dicarboxylic compound of the general formula (I):

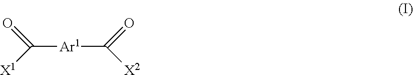

in which
Ar¹ is selected from the group consisting of unsubstituted or at least monosubstituted phenylene, naphthalenediyl, anthracenediyl, biphenyldiyl, diphenylmethanediyl, diphenyl etherdiyl, diphenylthio etherdiyl, diphenyl sulfonediyl, benzophenonediyl, pyridinediyl, pyrimidinediyl, furandiyl and thiophenediyl,
wherein the substituents are selected from the group consisting of —F, —Cl, —Br, —OR¹ and —C₁-C₁₀-alkyl,
wherein R¹ is —H or —C₁-C₁₀-alkyl;
   X¹, X² are each independently selected from the group consisting of —OR², —F, —Cl and —Br,
   wherein R² is —H, —C₁-C₁₀-alkyl, —C₁-C₁₀-alkenyl or a repeating unit of the general formula (Ia):

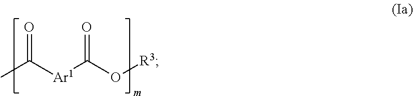

in which
m is a natural number from 1 to 50, and
R³ is —H, —C₁-C₁₀-alkyl or —C₁-C₁₀-alkenyl;
   (b) at least one aromatic diamino compound of the general formula (IIa), (IIb), (IIc) and/or (IId):

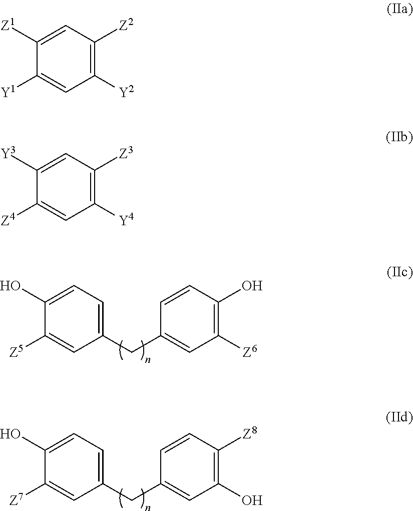

in which
n is 0 or 1
   Y¹, Y², Y³, Y⁴ are each independently —H, —OR⁴ or —SR⁴,
   wherein R⁴ is selected from the group consisting of —H, —C₁-C₁₀-alkyl, trimethylsilyl, tert-butyldimethylsilyl, acetyl and tert-butyloxycarbonyl, and
   wherein at most one of the radicals Y¹ and Y² is —H, and
   wherein at most one of the radicals Y³ and Y⁴ is —H;
Z¹, Z², Z³, Z⁴, Z⁵, Z⁶, Z⁷, Z⁸ are each independently —NH₂ or —NH₃⁺Q⁻,
   wherein Q⁻ is an anion equivalent selected from the group consisting of F⁻, Cl⁻, Br⁻, I⁻, HSO₄⁻, SO₄²⁻, H₃C—SO₃⁻, p-H₃C—C₆H₄—SO₃⁻ and NO₃⁻;
   and
   (c) at least one ionic liquid (IL);
   wherein the reaction of the reaction mixture (R_{G}) takes place at a temperature T_{R} in the range of 0 to 120° C. to obtain a product mixture (P_{VG}), processing of the product mixture (P_{VG}) to give films, fibers or moldings at a temperature T_{V} in the range of 0 to 100° C. and heating of the films, fibers or moldings thus obtained at a temperature T_{P} in the range of 250 to 500° C.

Surprisingly, it has been found that ionic liquids are well suited as solvents for producing the product mixture (P_{VG}) and the product mixture (P_{VG}) can be easily further processed in the presence of the ionic liquid solvent with the usual methods to give fibers, films and moldings and finally that these are converted by heating at a temperature in the range of 250 to 500° C. and optionally stretching into the fibers, films and moldings composed of polybenzazole polymers (P), for example PBO. Therefore, the acids used in the methods disclosed in the prior art, particularly polyphosphoric acid optionally with addition of diphosphorus pentoxide P₂O₅, are not required. The fibers, films and moldings composed of polybenzazole polymers (P), preferably PBO, obtained in the presence of ionic liquids, have as a result an increased resistance to aging processes and external environmental influences, for example hydrolysis or exposure to UV radiation.

By using ionic liquids, laborious separation or purification processes to remove acid esters from the polybenzazole polymer, preferably PBO, or the precursor of the polybenzazole polymer, are not required such that a more environmentally friendly and cost-effective process regime in the synthesis up to the further processing methods to give fibers, films and moldings is enabled. Due to the reusability of the ionic liquids in the production of the polybenzazole polymers (P), a significant improvement of the process regime is achieved compared to the methods disclosed in the prior art.

The present invention is elucidated in detail hereinbelow.

In the method according to the invention, fibers, films and moldings composed of polybenzazole polymer (P), preferably PBO, are obtained by reacting a reaction mixture (R_{G}) at a temperature in the range of 0 to 120° C. to obtain a product mixture (P_{VG}), processing the product mixture (P_{VG}), at a temperature T_{V} in the range of 0 to 100° C. to give fibers, films and moldings using customary methods and heating the fibers, films and moldings thus obtained, which comprise the polybenzazole polymer (P), preferably PBO, at a temperature in the range of 250 to 500° C.

Polybenzazole polymers are a class of polymers which are known in principle to those skilled in the art. In the context of the present invention, “polybenzazole polymer (P)” is understood to mean a polymer comprising repeating units of polybenzoxazole and/or polybenzothiazole.

In the context of the present invention, the term “polybenzoxazole” refers to polymers comprising repeating units of oxazole rings and aromatic groups. The aromatic groups in this case are not necessarily benzene rings.

In the context of the present invention, the term “polybenzothiazole” refers to polymers comprising repeating units of thiazole rings and aromatic groups. The aromatic groups in this case are not necessarily benzene rings.

The reaction mixture (R_{G}) is the mixture which is reacted to produce the polybenzazole polymer (P).

The reaction mixture (R_{G}) comprises as components at least one aromatic dicarboxylic compound of the general formula (I) (component (a)), at least one aromatic diamino compound of the general formula (IIa), (IIb), (IIc) and/or (IId) (component (b)) and at least one ionic liquid (IL) (component (c)).

Components (a) and (b) are usually practically dissolved completely in component (c). The expression “practically dissolved completely” signifies here that preferably at most 5% by weight, preferably at most 3% by weight, more preferably at most 2% by weight and particularly preferably at most 1% by weight of components (a) and (b) are present as solid particles in component (c), based on the total weight of components (a) and (b) in the reaction mixture (R_{G}). Very particularly preferably, component (c) comprises absolutely no solid particles of components (a) and (b). Consequently, components (a) and (b) very particularly preferably cannot be separated by filtration from component (c).

Components (a) and (b) can be dissolved in component (c) by all methods known to those skilled in the art. Preferably, components (a) and (b) are dissolved in component (c) with stirring. Components (a) and (b) can be dissolved simultaneously or preferably successively in component (c), for example firstly component b) and then a) or vice versa, preference being given to the variant firstly component b) and then a).

Components (a) or (b) are dissolved in component (c) preferably at elevated temperatures, preferably in the range of 20 to 120° C. and particularly preferably in the range of 60 to 90° C.

The molar ratio of component (a):component (b) is in the range from 1.05:1.00 to 1.01:1.00, preferably in the range from 1.01:1.00 to 1.00:1.00.

The reaction of component (a) with component (b) in the presence of component (c) takes place at a temperature in the range of 0 to 120° C., preferably in the range of 35 to 100° C., particularly preferably in the range of 70 to 80° C. In a preferred embodiment, component (b) is initially charged dissolved in component (c) and component (a) is added to this mixture, preferably in portions of the proposed total amount. Typically, the reaction of component (a) with component (b) in the presence of component (c) is conducted with stirring.

Reaction of components (a) and (b) under the conditions described in the presence of component (c) results in a precursor of the polybenzazole polymer (P), preferably of PBO, namely the product mixture (P_{VG}). Component (c) serves as solvent and preferably does not copolymerize here with components (a) and (b). In the event that a portion of component (c) copolymerizes with components (a) and (b), preferably at most 1% by weight, particularly preferably at most 0.5% by weight of component (c), based on the total weight of component (c), copolymerizes with components (a) and (b). Very particularly preferably, component (c) does not copolymerize at all with components (a) and (b).

The reaction mixture (R_{G}) according to the invention in one embodiment may comprise at least one basic compound. The at least one basic compound may in principle be any basic compound known to those skilled in the art. It is preferable when the at least one basic compound is a basic alkali metal or alkaline earth metal compound or amines. The at least one basic compound is particularly preferably selected from the group consisting of lithium hydroxide, sodium hydroxide, potassium hydroxide, magnesium hydroxide, calcium hydroxide, barium hydroxide, lithium carbonate, sodium carbonate, potassium carbonate, magnesium carbonate, calcium carbonate, lithium hydride, sodium hydride, potassium hydride, magnesium hydride, calcium hydride, triethylamine, tripropylamine, tributylamine, N-methylimidazole, N-ethylimidazole. The at least one basic compound (B) is very particularly preferably selected from the group consisting of sodium carbonate, potassium carbonate, lithium hydride, sodium hydride, magnesium hydride, calcium hydride, triethylamine, tripropylamine, tributylamine, N-methylimidazole, N-ethylimidazole.

The reaction mixture (R_{G}) can also comprise at least one inorganic salt which differs from the at least one basic compound defined above. The at least one inorganic salt can in principle be any inorganic salt known to those skilled in the art and can be precisely one inorganic salt and mixtures of two or more different inorganic salts. The at least one inorganic salt is preferably an alkali metal, alkaline earth metal, aluminum, tin(II), iron(II) or manganese(II) salt. The at least one inorganic salt is more preferably an alkali metal, alkaline earth metal, aluminum, tin(II), iron(II) or manganese(II) halide. The at least one inorganic salt is particularly preferably selected from the group consisting of lithium chloride, lithium bromide, lithium iodide, sodium chloride, sodium bromide, sodium iodide, potassium chloride, potassium bromide, potassium iodide, magnesium chloride, magnesium bromide, magnesium iodide, calcium chloride, calcium bromide, calcium iodide, barium chloride, barium bromide, barium iodide, aluminum chloride, aluminum bromide, aluminum iodide, tin(II) chloride, tin(II) bromide, tin(II) iodide, iron(II) chloride, iron(II) bromide, iron(II) iodide, manganese(II) chloride, manganese(II) bromide and manganese(II) iodide. The at least one inorganic salt is very particularly preferably selected from the group consisting of lithium chloride, sodium chloride, potassium chloride, magnesium chloride, calcium chloride, aluminium chloride, tin(II) chloride, iron(II) chloride and manganese(II) chloride.

Volatile by-products may form during the reaction of the reaction mixture (R_{G}) which are preferably already removed continuously during the reaction of the reaction mixture (R_{G}). In the context of the present invention, “volatile by-products” are understood to mean all compounds formed in the reaction of the reaction mixture (R_{G}) having a boiling point below 200° C., preferably below 150° C. and particularly preferably below 120° C. Preferred volatile by-products comprise, for example, water (water of reaction) or hydrogen halides. The volatile by-products can in principle be removed by all methods known to those skilled in the art. In a preferred embodiment, the volatile by-products are distilled off continuously during the reaction of the reaction mixture (R_{G}), optionally with continuous supply of a nitrogen stream.

All figures below relating to the reaction mixture (R_{G}) refer to the mixture prior to carrying out the reaction; the reaction is also referred to as “addition reaction” below. In the addition reaction, the reaction mixture (R_{G}) is reacted to give the product mixture (P_{VG}), which comprises the addition product, also called “aramid” herein, for example poly(ortho-hydroxy)aramid, and the at least one ionic liquid (IL). Consequently, all figures relating to the product mixture (P_{VG}) refer to the mixture after carrying out the addition reaction.

The reaction mixture (R_{G}) preferably comprises 5% by weight to 25% by weight component (a), 5% by weight to 25% by weight component (b) and 50% by weight to 90% by weight component (c), based on the total weight of the reaction mixture (R_{G}).

The reaction mixture (R_{G}) preferably comprises 8% by weight to 18% by weight component (a), 8% by weight to 18% by weight component (b) and 64% by weight to 84% by weight component (c), based on the total weight of the reaction mixture (R_{G}) and particularly preferably the reaction mixture (R_{G}) comprises 10% by weight to 15% by weight component (a), 10% by weight to 15% by weight component (b) and 70% by weight to 80% by weight component (c), based on the total weight of the reaction mixture (R_{G}).

In a further embodiment, the reaction mixture (R_{G}) may additionally comprise at least one linear or branched aliphatic dicarboxylic compound as comonomer. The at least one linear or branched aliphatic dicarboxylic compound preferably comprises 2 to 20 carbon atoms. Particularly preferred linear or branched aliphatic dicarboxylic compounds are oxalic acid, malonic acid, succinic acid, glutaric acid, adipic acid, pimelic acid, suberic acid, azelaic acid, sebacic acid and branched isomers thereof.

The product mixture (P_{VG}) preferably generally comprises 5% by weight to 25% by weight, preferably 10% by weight to 22% by weight and particularly preferably 12% by weight to 20% by weight of the aramid, based on the total weight of the product mixture (P_{VG}).

The aramid is preferably at least partially dissolved in the at least one ionic liquid (IL). Preferably at least 40% by weight, particularly preferably at least 60% by weight and very particularly preferably at least 80% by weight of the aramid is dissolved in the at least one ionic liquid (IL), based on the total weight of the aramid in the product mixture (P_{VG}). The aramid is very particularly preferably practically completely dissolved in the at least one ionic liquid (IL) for the further processing to give fibers or films, particularly fibers. The expression “practically dissolved completely” signifies here that preferably at most 5% by weight, preferably at most 3% by weight, more preferably at most 2% by weight and particularly preferably at most 1% by weight of the aramid is present as solid particles in the at least one ionic liquid (IL), based on the total weight of the aramid in the product mixture (P_{VG}). Very particularly preferably, the at least one ionic liquid (IL) comprises absolutely no solid particles of the aramid. Consequently, the aramid very particularly preferably cannot be separated by filtration from the at least one ionic liquid (IL).

The aramid can be separated from the product mixture (P_{VG}) by all methods known to those skilled in the art. For example, the aramid can be precipitated from the product mixture (P_{VG}) by adding a suitable precipitant. Suitable precipitants are known in principle to those skilled in the art and comprise aprotic or protic polar solvents, preferably protic polar solvents such as water, methanol, ethanol, n-propanol, isopropanol, glycerol, ethylene glycol or mixtures thereof.

The components (a), (b) and (c) are elucidated in detail hereinafter.

### Component (a)

The reaction mixture (R_{G}) comprises at least one aromatic dicarboxylic compound of the general formula (I) as component (a).

The expressions “component (a)”, “at least one aromatic dicarboxylic compound of the general formula (I)” and “at least one aromatic dicarboxylic compound (I)” are used synonymously hereinbelow.

The expression “at least one aromatic dicarboxylic compound of the general formula (I)” refers here precisely to one aromatic dicarboxylic compound of the general formula (I) and also to mixtures of two or more different aromatic dicarboxylic compounds of the general formula (I). Suitable aromatic dicarboxylic compounds of the general formula (I) are known in principle to those skilled in the art.

The at least one aromatic dicarboxylic compound used in the method according to the invention has the general formula (I):

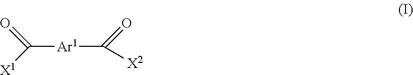

in which
Ar¹ is selected from the group consisting of unsubstituted or at least monosubstituted phenylene, naphthalenediyl, anthracenediyl, biphenyldiyl, diphenylmethanediyl, diphenyl etherdiyl, diphenylthio etherdiyl, diphenyl sulfonediyl, benzophenonediyl, pyridinediyl, pyrimidinediyl, furandiyl and thiophenediyl,
wherein the substituents are selected from the group consisting of —F, —Cl, —Br, —OR¹ and —C₁-C₁₀-alkyl,
wherein R¹ is —H or —C₁-C₁₀-alkyl;
X¹, X² are each independently selected from the group consisting of —OR², —F, —Cl and —Br, wherein R² is —H, —C₁-C₁₀-alkyl, —C₁-C₁₀-alkenyl or a repeating unit of the general formula (Ia):

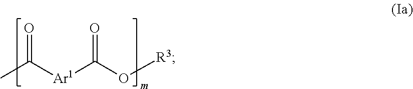

in which
m is a natural number from 1 to 50, and
R³ is —H, —C₁-C₁₀-alkyl or —C₁-C₁₀-alkenyl.

The at least one aromatic dicarboxylic compound of the general formula (I) used in the method according to the invention preferably comprises two functional groups which are each independently selected from the group consisting of carboxylic groups (—CO₂H), carbonyl fluorides (—COF), carbonyl chlorides (—OCl), carbonyl bromides (—COBr), carboxylic esters (—CO₂R², in which R² is a C₁-C₁₀-alkyl group or a C₁-C₁₀-alkenyl group) and carboxylic anhydrides (—CO₂R², in which R² is a repeating unit of the general formula (Ia) defined above).

Ar¹ in the method according to the invention is selected from the group consisting of unsubstituted or at least monosubstituted phenylene, naphthalenediyl, anthracenediyl, biphenyldiyl, diphenylmethanediyl, diphenyl etherdiyl, diphenylthio etherdiyl, diphenyl sulfonediyl, benzophenonediyl, pyridinediyl, pyrimidinediyl, furandiyl and thiophenediyl. Relevant suitable aromatic dicarboxylic compounds of the general formula (I) are known in principle to those skilled in the art. In principle, all appropriate aromatic dicarboxylic compounds of the general formula (I) known to those skilled in the art can be used in the method according to the invention.

For the radical Ar¹, suitable unsubstituted or at least monosubstituted phenylene groups are selected, for example, from the group consisting of 1,2-phenylene, 1,3-phenylene and 1,4-phenylene, preferably 1,4-phenylene. The phenylene groups are preferably unsubstituted. Relevant aromatic dicarboxylic compounds (I) having a phenylene group as radical Ar¹ include, for example, phthalic acid, isophthalic acid, terephthalic acid, phthalic anhydride, phthaloyl difluoride, phthaloyl dichloride, phthaloyl dibromide, isophthalic anhydride, isophthaloyl difluoride, isophthaloyl dichloride, isophthaloyl dibromide, terephthalic anhydride, terephthaloyl difluoride, terephthaloyl dichloride, terephthaloyl dibromide, polyanhydrides of phthalic acid, polyanhydrides of isophthalic acid, polyanhydrides of terephthalic acid and also C₁-C₁₀-alkyl esters of phthalic acid, isophthalic acid and terephthalic acid and C₁-C₁₀-alkenyl esters of phthalic acid, isophthalic acid and terephthalic acid.

For the radical Ar¹, suitable unsubstituted or at least monosubstituted naphthalenediyl groups are, for example, selected from the group consisting of naphthalene-1,4-diyl, naphthalene-1,5-diyl, naphthalene-2,6-diyl and naphthalene-2,7-diyl, preferably naphthalene-1,4-diyl and naphthalene-2,6-diyl. The naphthalene groups are preferably unsubstituted. Appropriate aromatic dicarboxylic compounds (I) having a naphthalenediyl group as radical Ar¹ include, for example, naphthalene-1,4-dicarboxylic acid, naphthalene-1,5-dicarboxylic acid, naphthalene-2,6-dicarboxylic acid, naphthalene-2,7-dicarboxylic acid, naphthalene-1,4-dicarboxylic anhydride, naphthalene-1,4-dicarbonyl difluoride, naphthalene-1,4-dicarbonyl dichloride, naphthalene-1,4-dicarbonyl dibromide, naphthalene-1,5-dicarboxylic anhydride, naphthalene-1,5-dicarbonyl difluoride, naphthalene-1,5-dicarbonyl dichloride, naphthalene-1,5-dicarbonyl dibromide, naphthalene-2,6-dicarboxylic anhydride, naphthalene-2,6-dicarbonyl difluoride, naphthalene-2,6-dicarbonyl dichloride, naphthalene-2,6-dicarbonyl dibromide, naphthalene-2,7-dicarboxylic anhydride, naphthalene-2,7-dicarbonyl difluoride, naphthalene-2,7-dicarbonyl dichloride, naphthalene-2,7-dicarbonyl dibromide, polyanhydrides of naphthalene-1,4-dicarboxylic acid, polyanhydrides of naphthalene-1,5-dicarboxylic acid, polyanhydrides of naphthalene-2,6-dicarboxylic acid, polyanhydrides of naphthalene-2,7-dicarboxylic acid and also C₁-C₁₀-alkyl esters of naphthalene-1,4-dicarboxylic acid, naphthalene-1,5-dicarboxylic acid, naphthalene-2,6-dicarboxylic acid and naphthalene-2,7-dicarboxylic acid and C₁-C₁₀-alkenyl esters of naphthalene-1,4-dicarboxylic acid, naphthalene-1,5-dicarboxylic acid, naphthalene-2,6-dicarboxylic acid and naphthalene-2,7-dicarboxylic acid.

For the radical Ar¹, suitable unsubstituted or at least monosubstituted anthracenediyl groups are, for example, selected from the group consisting of anthracene-1,4-diyl, anthracene-1,5-diyl, anthracene-2,6-diyl and anthracene-9,10-diyl, preferably anthracene-2,6-diyl and anthracene-9,10-diyl. The anthracene groups are preferably unsubstituted. Appropriate aromatic dicarboxylic compounds (I) having an anthracenediyl group as radical Ar¹ comprise, for example, anthracene-1,4-dicarboxylic acid, anthracene-1,5-dicarboxylic acid, anthracene-2,6-dicarboxylic acid, anthracene-9,10-dicarboxylic acid, anthracene-1,4-dicarbonyl difluoride, anthracene-1,4-dicarboxylic anhydride, anthracene-1,4-dicarbonyl dichloride, anthracene-1,4-dicarbonyl dibromide, anthracene-1,5-dicarboxylic anhydride, anthracene-1,5-dicarbonyl difluoride, anthracene-1,5-dicarbonyl dichloride, anthracene-1,5-dicarbonyl dibromide, anthracene-2,6-dicarboxylic anhydride, anthracene-2,6-dicarbonyl difluoride, anthracene-2,6-dicarbonyl dichloride, anthracene-2,6-dicarbonyl dibromide, anthracene-9,10-dicarboxylic anhydride, anthracene-9,10-dicarbonyl difluoride, anthracene-9,10-dicarbonyl dichloride, anthracene-9,10-dicarbonyl dibromide, polyanhydrides of anthracene-1,4-dicarboxylic acid, polyanhydrides of anthracene-1,5-dicarboxylic acid, polyanhydrides of anthracene-2,6-dicarboxylic acid, polyanhydrides of anthracene-9,10-dicarboxylic acid and also C₁-C₁₀-alkyl esters of anthracene-1,4-dicarboxylic acid, anthracene-1,5-dicarboxylic acid, anthracene-2,6-dicarboxylic acid and anthracene-9,10-dicarboxylic acid and C₁-C₁₀-alkenyl esters of anthracene-1,4-dicarboxylic acid, anthracene-1,5-dicarboxylic acid, anthracene-2,6-dicarboxylic acid and anthracene-9,10-dicarboxylic acid.

For the radical Ar¹, suitable unsubstituted or at least monosubstituted biphenyldiyl groups are, for example, selected from the group consisting of biphenyl-3,3′-diyl and biphenyl-4,4′-diyl, preferably biphenyl-4,4′-diyl. The biphenyldiyl groups are preferably unsubstituted. Appropriate aromatic dicarboxylic compounds having a biphenyldiyl group as radical Ar¹ comprise, for example, biphenyl-3,3′-dicarboxylic acid, biphenyl-4,4′-dicarboxylic acid, biphenyl-3,3′-dicarboxylic anhydride, biphenyl-3,3′-dicarbonyl difluoride, biphenyl-3,3′-dicarbonyl dichloride, biphenyl-3,3′-dicarbonyl dibromide, biphenyl-4,4′-dicarboxylic anhydride, biphenyl-4,4′-dicarbonyl difluoride, biphenyl-4,4′-dicarbonyl dichloride, biphenyl-4,4′-dicarbonyl dibromide, polyanhydrides of biphenyl-3,3′-dicarboxylic acid, polyanhydrides of biphenyl-4,4′-dicarboxylic acid and also C₁-C₁₀-alkyl esters of biphenyl-3,3′-dicarboxylic acid and biphenyl-4,4′-dicarboxylic acid and C₁-C₁₀-alkenyl esters of biphenyl-3,3′-dicarboxylic acid and biphenyl-4,4′-dicarboxylic acid.

For the radical Ar¹, suitable unsubstituted or at least monosubstituted diphenylmethanediyl groups are, for example, selected from the group consisting of diphenylmethane-3,3′-diyl and diphenylmethane-4,4′-diyl, preferably diphenylmethane-4,4′-diyl. The diphenylmethanediyl groups are preferably unsubstituted. Appropriate aromatic dicarboxylic compounds (I) having a diphenylmethanediyl group as radical Ar¹ comprise, for example, diphenylmethane-3,3′-dicarboxylic acid, diphenylmethane-4,4′-dicarboxylic acid, diphenylmethane-3,3′-dicarboxylic anhydride, diphenylmethane-3,3′-dicarbonyl difluoride, diphenylmethane-3,3′-dicarbonyl dichloride, diphenylmethane-3,3′-dicarbonyl dibromide, diphenylmethane-4,4′-dicarboxylic anhydride diphenylmethane-4,4′-dicarbonyl difluoride, diphenylmethane-4,4′-dicarbonyl dichloride, diphenylmethane-4,4′-dicarbonyl dibromide, polyanhydrides of diphenylmethane-3,3′-dicarboxylic acid, polyanhydrides of diphenylmethane-4,4′-dicarboxylic acid and also C₁-C₁₀-alkyl esters of diphenylmethane-3,3′-dicarboxylic acid and diphenylmethane-4,4′-dicarboxylic acid and C₁-C₁₀-alkenyl esters of diphenylmethane-3,3′-dicarboxylic acid and diphenylmethane-4,4′-dicarboxylic acid.

For the radical Ar¹, suitable unsubstituted or at least monosubstituted diphenyl ether diyl groups are, for example, selected from the group consisting of diphenyl ether 3,3′-diyl and diphenyl ether 4,4′-diyl, preferably diphenyl ether 4,4′-diyl. The diphenyl ether diyl groups are preferably unsubstituted. Appropriate aromatic dicarboxylic compounds (I) having a diphenyl ether diyl group as radical Ar¹ comprise, for example, diphenyl ether 3,3′-dicarboxylic acid, diphenyl ether 4,4′-dicarboxylic acid, diphenyl ether 3,3′-dicarboxylic anhydride, diphenyl ether 3,3′-dicarbonyl difluoride, diphenyl ether 3,3′-dicarbonyl dichloride, diphenyl ether 3,3′-dicarbonyl dibromide, diphenyl ether 4,4′-dicarboxylic anhydride, diphenyl ether 4,4′-dicarbonyl difluoride, diphenyl ether 4,4′-dicarbonyl dichloride, diphenyl ether 4,4′-dicarbonyl dibromide, polyanhydrides of diphenyl ether 3,3′-dicarboxylic acid, polyanhydrides of diphenyl ether 4,4′-dicarboxylic acid and also C₁-C₁₀-alkyl esters of diphenyl ether 3,3′-dicarboxylic acid and diphenyl ether 4,4′-dicarboxylic acid and C₁-C₁₀-alkenyl esters of diphenyl ether 3,3′-dicarboxylic acid and diphenyl ether 4,4′-dicarboxylic acid.

For the radical Ar¹, suitable unsubstituted or at least monosubstituted diphenyl thioether diyl groups are, for example, selected from the group consisting of diphenyl thioether 3,3′-diyl and diphenyl thioether 4,4′-diyl, preferably diphenyl thioether 4,4′-diyl. The diphenyl thioether diyl groups are preferably unsubstituted. Appropriate aromatic dicarboxylic compounds (I) having a diphenyl thioether diyl group as radical Ar¹ comprise, for example, diphenyl thioether 3,3′-dicarboxylic acid, diphenyl thioether 4,4′-dicarboxylic acid, diphenyl thioether 3,3′-dicarbonyl difluoride, diphenyl thioether 3,3′-dicarboxylic anhydride, diphenyl thioether 3,3′-dicarbonyl dichloride, diphenyl thioether 3,3′-dicarbonyl dibromide, diphenyl thioether 4,4′-dicarboxylic anhydride, diphenyl thioether 4,4′-dicarbonyl difluoride, diphenyl thioether 4,4′-dicarbonyl dichloride, diphenyl thioether 4,4′-dicarbonyl dibromide, polyanhydrides of diphenyl thioether 3,3′-dicarboxylic acid, polyanhydrides of diphenyl thioether 4,4′-dicarboxylic acid and also C₁-C₁₀-alkyl esters of diphenyl thioether 3,3′-dicarboxylic acid and diphenyl thioether 4,4′-dicarboxylic acid and C₁-C₁₀-alkenyl esters of diphenyl thioether 3,3′-dicarboxylic acid and diphenyl thioether 4,4′-dicarboxylic acid.

For the radical Ar¹, suitable unsubstituted or at least monosubstituted diphenyl sulfone diyl groups are, for example, selected from the group consisting of diphenyl sulfone 3,3′-diyl and diphenyl sulfone 4,4′-diyl, preferably diphenyl sulfone 4,4′-diyl. The diphenyl sulfone diyl groups are preferably unsubstituted. Appropriate aromatic dicarboxylic compounds (I) having a diphenyl sulfone diyl group as radical Ar¹ comprise, for example, diphenyl sulfone 3,3′-dicarboxylic acid, diphenyl sulfone 4,4′-dicarboxylic acid, diphenyl sulfone 3,3′-dicarboxylic anhydride, diphenyl sulfone 3,3′-dicarbonyl difluoride, diphenyl sulfone 3,3′-dicarbonyl dichloride, diphenyl sulfone 3,3′-dicarbonyl dibromide, diphenyl sulfone 4,4′-dicarboxylic acid, diphenyl sulfone 4,4′-dicarbonyl difluoride, diphenyl sulfone 4,4′-dicarbonyl dichloride, diphenyl sulfone 4,4′-dicarbonyl dibromide, polyanhydrides of diphenyl sulfone 3,3′-dicarboxylic acid, polyanhydrides of diphenyl sulfone 4,4′-dicarboxylic acid and also C₁-C₁₀-alkyl esters of diphenyl sulfone 3,3′-dicarboxylic acid and diphenyl sulfone 4,4′-dicarboxylic acid and C₁-C₁₀-alkenyl esters of diphenyl sulfone 3,3′-dicarboxylic acid and diphenyl sulfone 4,4′-dicarboxylic acid.

For the radical Ar¹, suitable unsubstituted or at least monosubstituted benzophenonediyl groups are, for example, selected from the group consisting of benzophenone-3,3′-diyl and benzophenone-4,4′-diyl, preferably benzophenone-4,4′-diyl. The benzophenonediyl groups are preferably unsubstituted. Appropriate aromatic dicarboxylic compounds (I) having a benzophenonediyl group as radical Ar¹ comprise, for example, benzophenone-3,3′-dicarboxylic acid, benzophenone-4,4′-dicarboxylic acid, benzophenone-3,3′-dicarboxylic anhydride, benzophenone-3,3′-dicarbonyl difluoride, benzophenone-3,3′-dicarbonyl dichloride, benzophenone-3,3′-dicarbonyl dibromide, benzophenone-4,4′-dicarboxylic anhydride, benzophenone-4,4′-dicarbonyl difluoride, benzophenone-4,4′-dicarbonyl dichloride, benzophenone-4,4′-dicarbonyl dibromide, polyanhydrides of benzophenone-3,3′-dicarboxylic acid, polyanhydrides of benzophenone-4,4′-dicarboxylic acid and also C₁-C₁₀-alkyl esters of benzophenone-3,3′-dicarboxylic acid and benzophenone-4,4′-dicarboxylic acid and C₁-C₁₀-alkenyl esters of benzophenone-3,3′-dicarboxylic acid and benzophenone-4,4′-dicarboxylic acid. For the radical Ar¹, suitable unsubstituted or at least monosubstituted pyridinediyl groups are, for example, selected from the group consisting of pyridine-2,5-diyl, pyridine-2,6-diyl and pyridine-3,5-diyl, preferably pyridine-2,5-diyl. The pyridinediyl groups are preferably unsubstituted. Appropriate aromatic dicarboxylic compounds (I) having a pyridinediyl group as radical Ar¹ comprise, for example, pyridine-2,5-dicarboxylic acid, pyridine-2,6-dicarboxylic acid, pyridine-3,5-carboxylic acid, pyridine-2,5-dicarboxylic anhydride, pyridine-2,5-dicarbonyl difluoride, pyridine-2,5-dicarbonyl dichloride, pyridine-2,5-dicarbonyl dibromide, pyridine-2,6-dicarboxylic anhydride, pyridine-2,6-dicarbonyl difluoride, pyridine-2,6-dicarbonyl dichloride, pyridine-2,6-dicarbonyl dibromide, pyridine-3,5-dicarboxylic anhydride, pyridine-3,5-dicarbonyl difluoride, pyridine-3,5-dicarbonyl dichloride, pyridine-3,5-dicarbonyl dibromide, polyanhydrides of pyridine-2,5-dicarboxylic acid, polyanhydrides of pyridine-2,6-dicarboxylic acid, polyanhydrides of pyridine-3,5-dicarboxylic acid and also C₁-C₁₀-alkyl esters of pyridine-2,5-dicarboxylic acid, pyridine-2,6-dicarboxylic acid and pyridine-3,5-dicarboxylic acid and C₁-C₁₀-alkenyl esters of pyridine-2,5-dicarboxylic acid, pyridine-2,6-dicarboxylic acid and pyridine-3,5-dicarboxylic acid.

For the radical Ar¹, suitable unsubstituted or at least monosubstituted pyrimidinediyl groups are, for example, selected from the group consisting of pyrimidine-2,4-diyl, pyrimidine-2,5-diyl and pyrimidine-4,6-diyl, preferably pyrimidine-4,6-diyl. The pyrimidinediyl groups are preferably unsubstituted. Appropriate aromatic dicarboxylic compounds (I) having a pyrimidinediyl group as radical Ar¹ comprise, for example, pyrimidine-2,4-dicarboxylic acid, pyrimidine-2,5-dicarboxylic acid, pyrimidine-4,6-carboxylic acid, pyrimidine-2,4-dicarboxylic anhydride, pyrimidine-2,4-dicarbonyl difluoride, pyrimidine-2,4-dicarbonyl dichloride, pyrimidine-2,4-dicarbonyl dibromide, pyrimidine-2,5-dicarboxylic anhydride, pyrimidine-2,5-dicarbonyl difluoride, pyrimidine-2,5-dicarbonyl dichloride, pyrimidine-2,5-dicarbonyl dibromide, pyrimidine-4,6-dicarboxylic anhydride, pyrimidine-4,6-dicarbonyl difluoride, pyrimidine-4,6-dicarbonyl dichloride, pyrimidine-4,6-dicarbonyl dibromide, polyanhydrides of pyrimidine-2,4-dicarboxylic acid, polyanhydrides of pyrimidine-2,5-dicarboxylic acid, polyanhydrides of pyrimidine-4,6-dicarboxylic acid and also C₁-C₁₀-alkyl esters of pyrimidine-2,4-dicarboxylic acid, pyrimidine-2,5-dicarboxylic acid and pyrimidine-4,6-dicarboxylic acid and C₁-C₁₀-alkenyl esters of pyrimidine-2,4-dicarboxylic acid, pyrimidine-2,5-dicarboxylic acid and pyrimidine-4,6-dicarboxylic acid.

For the radical Ar¹, suitable unsubstituted or at least monosubstituted furandiyl groups are, for example, selected from furan-2,5-diyl. The furandiyl group is preferably unsubstituted. Appropriate aromatic dicarboxylic compounds (I) having a furandiyl group as radical Ar¹ comprise, for example, furan-2,5-dicarboxylic acid, furan-2,5-dicarboxylic anhydride, furan-2,5-dicarbonyl difluoride, furan-2,5-dicarbonyl dichloride, furan-2,5-dicarbonyl dibromide, polyanhydrides of furan-2,5-dicarboxylic acid, C₁-C₁₀-alkyl esters of furan-2,5dicarboxylic acid and C₁-C₁₀-alkenyl esters of furan-2,5-dicarboxylic acid.

For the radical Ar¹, suitable unsubstituted or at least monosubstituted thiophenediyl groups are, for example, selected from thiophene-2,5-diyl. The thiophenediyl group is preferably unsubstituted. Appropriate aromatic dicarboxylic compounds (I) having a thiophenediyl group as radical Ar¹ comprise, for example, thiophene-2,5-dicarboxylic acid, thiophene-2,5-dicarboxylic anhydride, thiophene-2,5-dicarbonyl difluoride, thiophene-2,5-dicarbonyl dichloride, thiophene-2,5-dicarbonyl dibromide, polyanhydrides of thiophene-2,5-dicarboxylic acid, C₁-C₁₀-alkyl esters of thiophene-2,5-dicarboxylic acid and C₁-C₁₀-alkenyl esters of thiophene-2,5-dicarboxylic acid.

The radical Ar¹ is preferably selected from the group consisting of unsubstituted or at least monosubstituted 1,3-phenylene, 1,4-phenylene, naphthalene-1,4-diyl, naphthalene-2,6-diyl, anthracene-2,6-diyl, anthracene-9,10-diyl, biphenyl-4,4′-diyl, diphenylmethane-4,4′-diyl, diphenyl ether 4,4′-diyl, diphenyl thioether 4,4′-diyl, diphenyl sulfone 4,4′-diyl, benzophenone-4,4-diyl, pyridine-2,5-diyl, pyrimidine-4,6-diyl, furan-2,5-diyl and thiophene-2,5-diyl. The radicals specified above are particularly preferably unsubstituted.

The present invention therefore also relates to a method, characterized in that Ar¹ is selected from the group consisting of unsubstituted or at least monosubstituted 1,3-phenylene, 1,4-phenylene, naphthalene-1,4-diyl, naphthalene-2,6-diyl, anthracene-2,6-diyl, anthracene-9,10-diyl, biphenyl-4,4′-diyl, diphenylmethane-4,4′-diyl, diphenyl ether 4,4′-diyl, diphenyl thioether 4,4′diyl, diphenyl sulfone 4,4′diyl, benzophenone-4,4′diyl, pyridine-2,5-diyl, pyrimidine-4,6-diyl, furan-2,5-diyl and thiophene-2,5-diyl.

In the context of the present invention, the term “unsubstituted” signifies that the radical Ar¹ has no further substituents other than hydrogen (—H) besides the functional groups (—COX¹ and —COX²) depicted in the general formula (I).

In the context of the present invention, the expression “at least monosubstituted” signifies that the radical Ar¹, in addition to the functional groups depicted in the general formula (I), may have exactly one substituent or also two or more substituents in addition to the carboxyl groups depicted in the general formula (I).

Preferred C₁-C₁₀-alkyl groups comprise linear and branched, saturated alkyl groups having 1 to 10 carbon atoms. Particularly preferred C₁-C₁₀-alkyl groups here are C₁-C₆-alkyl groups such as methyl, ethyl, n-propyl, isopropyl, n-butyl, sec-butyl, 2- or 3-methylpentyl or longer-chain groups such as n-heptyl, n-octyl, n-nonyl or n-decyl and also branched isomers thereof.

Preferred C₁-C₁₀-alkenyl groups comprise linear and branched, at least monounsaturated alkyl groups having 1 to 10 carbon atoms. Particularly preferred C₁-C₁₀-alkenyl groups here are vinyl, allyl, isopropenyl, 1-butenyl, crotyl, 3-butenyl, 1,3-butadienyl or longer-chain groups such as pentenyl, pentadienyl, hexenyl, hexadienyl, hexatrienyl, heptenyl, heptadienyl, heptatrienyl, octenyl, octadienyl, octatrienyl, octatetraenyl, nonenyl, nonadienyl, nonatrienyl, nonatetradienyl, decenyl, decadienyl, decatrienyl, decatetraenyl or decapentaenyl and also branched isomers thereof.

m in the repeating unit of the general formula (Ia) is preferably a natural number from 1 to 50, particularly preferably from 1 to 30, very particularly preferably from 1 to 10 and especially from 1 to 5. Most preferably, m is 1.

Component (a) is preferably selected from the group consisting of isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid, C₁-C₁₀-alkenyl esters of isophthalic acid, terephthalic acid, terephthalic anhydride, terephthaloyl difluoride, terephthaloyl dichloride, terephthaloyl dibromide, polyanhydrides of terephthalic acid, C₁-C₁₀-alkyl esters of terephthalic acid, C₁-C₁₀-alkenyl esters of terephthalic acid, naphthalene-1,4-dicarboxylic acid, naphthalene-1,4-dicarboxylic anhydride, naphthalene-1,4-dicarbonyl difluoride, naphthalene-1,4-dicarbonyl dichloride, naphthalene-1,4-dicarbonyl bromide, polyanhydrides of naphthalene-1,4-dicarboxylic acid, C₁-C₁₀-alkyl esters of naphthalene-1,4-dicarboxylic acid, C₁-C₁₀-alkenyl esters of naphthalene-1,4-dicarboxylic acid, naphthalene-2,6-dicarboxylic acid, naphthalene-2,6-dicarboxylic anhydride, naphthalene-2,6-dicarbonyl difluoride, naphthalene-2,6-dicarbonyl dichloride, naphthalene-2,6-dicarbonyl dibromide, polyanhydrides of naphthalene-2,6-dicarboxylic acid, C₁-C₁₀-alkyl esters of naphthalene-2,6-dicarboxylic acid, C₁-C₁₀-alkenyl esters of naphthalene-2,6-dicarboxylic acid, anthracene-2,6-dicarboxylic acid, anthracene-2,6-dicarboxylic anhydride, anthracene-2,6-dicarbonyl difluoride, anthracene-2,6-dicarbonyl dichloride, anthracene-2,6-dicarbonyl dibromide, polyanhydrides of anthracene-2,6-dicarboxylic acid, C₁-C₁₀-alkyl esters of anthracene-2,6-dicarboxylic acid, C₁-C₁₀-alkenyl esters of anthracene-2,6-dicarboxylic acid, anthracene-9,10-dicarboxylic acid, anthracene-9,10-dicarboxylic anhydride, anthracene-9,10-dicarbonyl difluoride, anthracene-9,10-dicarbonyl dichloride, anthracene-9,10-dicarbonyl dibromide, polyanhydrides of anthracene-9,10-dicarboxylic acid, C₁-C₁₀-alkyl esters of anthracene-9,10-dicarboxylic acid, C₁-C₁₀-alkenyl esters of anthracene-9,10-dicarboxylic acid, biphenyl-4,4′-dicarboxylic acid, biphenyl-4,4′-dicarboxylic anhydride, biphenyl-4,4′-dicarbonyl difluoride, biphenyl-4,4′-dicarbonyl dichloride, biphenyl-4,4′-dicarbonyl dibromide, polyanhydrides of biphenyl-4,4′-dicarboxylic acid, C₁-C₁₀-alkyl esters of biphenyl-4,4′-dicarboxylic acid, C₁-C₁₀-alkenyl esters of biphenyl-4,4′-dicarboxylic acid, diphenylmethane-4,4′-dicarboxylic acid, diphenylmethane-4,4′-dicarboxylic anhydride, diphenylmethane-4,4′-dicarbonyl difluoride, diphenylmethane-4,4′-dicarbonyl dichloride, diphenylmethane-4,4′-dicarbonyl dibromide, polyanhydrides of diphenylmethane-4,4′-dicarboxylic acid, C₁-C₁₀-alkyl esters of diphenylmethane-4,4′-dicarboxylic acid, C₁-C₁₀-alkenyl esters of diphenylmethane-4,4′-dicarboxylic acid, diphenyl ether 4,4′-dicarboxylic acid, diphenyl ether 4,4′-dicarboxylic anhydride, diphenyl ether 4,4′-dicarbonyl difluoride, diphenyl ether 4,4′-dicarbonyl dichloride, diphenyl ether 4,4′-dicarbonyl dibromide, polyanhydrides of diphenyl ether 4,4′-dicarboxylic acid, C₁-C₁₀-alkyl esters of diphenyl ether 4,4′-dicarboxylic acid, C₁-C₁₀-alkenyl esters of diphenyl ether 4,4′-dicarboxylic acid, diphenyl thioether 4,4′-dicarboxylic acid, diphenyl thioether 4,4′-dicarboxylic anhydride, diphenyl thioether-4,4′-dicarbonyl difluoride, diphenyl thioether 4,4′-dicarbonyl dichloride, diphenyl thioether 4,4′-dicarbonyl dibromide, polyanhydrides of diphenyl thioether 4,4′-dicarboxylic acid, C₁-C₁₀-alkyl esters of diphenyl thioether 4,4′-dicarboxylic acid, C₁-C₁₀-alkenyl esters of diphenyl thioether 4,4′-dicarboxylic acid, diphenyl sulfone 4,4′-dicarboxylic acid, diphenyl sulfone 4,4′-dicarboxylic anhydride, diphenyl sulfone 4,4′-dicarbonyl difluoride, diphenyl sulfone 4,4′-dicarbonyl dichloride, diphenyl sulfone 4,4′-dicarbonyl dibromide, polyanhydrides of diphenyl sulfone 4,4′-dicarboxylic acid, C₁-C₁₀-alkyl esters of diphenyl sulfone 4,4′-dicarboxylic acid, C₁-C₁₀-alkenyl esters of diphenyl sulfone 4,4′-dicarboxylic acid, benzophenone-4,4′-dicarboxylic acid, benzophenone-4,4′-dicarboxylic anhydride, benzophenone-4,4′-dicarbonyl difluoride, benzophenone-4,4′-dicarbonyl dichloride, benzophenone-4,4′-dicarbonyl dibromide, polyanhydrides of benzophenone-4,4′-dicarboxylic acid, C₁-C₁₀-alkyl esters of benzophenone-4,4′-dicarboxylic acid, C₁-C₁₀-alkenyl esters of benzophenone-4,4′-dicarboxylic acid, pyridine-2,5-dicarboxylic acid, pyridine-2,5-dicarboxylic anhydride, pyridine-2,5-dicarbonyl difluoride, pyridine-2,5-dicarbonyl dichloride, pyridine-2,5-dicarbonyl dibromide, polyanhydrides of pyridine-2,5-dicarboxylic acid, C₁-C₁₀-alkyl esters of pyridine-2,5-dicarboxylic acid, C₁-C₁₀-alkenyl esters of pyridine-2,5-dicarboxylic acid, pyrimidine-4,6-dicarboxylic acid, pyrimidine-4,6-dicarboxylic anhydride, pyrimidine-4,6-dicarbonyl difluoride, pyrimidine-4,6-dicarbonyl dichloride, pyrimidine-4,6-dicarbonyl dibromide, polyanhydrides of pyrimidine-4,6-dicarboxylic acid, C₁-C₁₀-alkyl esters of pyrimidine-4,6-dicarboxylic acid, C₁-C₁₀-alkenyl esters of pyrimidine-4,6-dicarboxylic acid, furan-2,5-dicarboxylic acid, furan-2,5-dicarboxylic anhydride, furan-2,5-dicarbonyl difluoride, furan-2,5-dicarbonyl dichloride, furan-2,5-dicarbonyl dibromide, polyanhydrides of furan-2,5-dicarboxylic acid, C₁-C₁₀-alkyl esters of furan-2,5-dicarboxylic acid, C₁-C₁₀-alkenyl esters of furan-2,5-dicarboxylic acid, thiophene-2,5-dicarboxylic acid, thiophene-2,5-dicarboxylic anhydride, thiophene-2,5-dicarbonyl difluoride, thiophene-2,5-dicarbonyl dichloride, thiophene-2,5-dicarbonyl dibromide, polyanhydrides of thiophene-2,5-dicarboxylic acid, C₁-C₁₀-alkyl esters of thiophene-2,5-dicarboxylic acid and C₁-C₁₀-alkenyl esters of thiophene-2,5-dicarboxylic acid.

Component (a) is particularly preferably selected from the group consisting of terephthalic acid, terephthalic anhydride, terephthaloyl difluoride, terephthaloyl dichloride, terephthaloyl dibromide, C₁-C₁₀-alkyl esters of terephthalic acid, C₁-C₁₀-alkenyl esters of terephthalic acid, isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid and C₁-C₁₀-alkenyl esters of isophthalic acid.

In a preferred embodiment, component (a) comprises at least 80% by weight, particularly preferably at least 90% by weight and very particularly preferably at least 98% by weight of at least one aromatic dicarboxylic compound of the general formula (I) selected from the group consisting of terephthalic acid, terephthalic anhydride, terephthaloyl difluoride, terephthaloyl dichloride, terephthaloyl dibromide, C₁-C₁₀-alkyl esters of terephthalic acid, C₁-C₁₀-alkenyl esters of terephthalic acid, isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid and C₁-C₁₀-alkenyl esters of isophthalic acid, based on the total weight of component (a) in the reaction mixture (R_{G}). The weight data specified here with respect to component (a) refers in this case to the total amount used of terephthalic acid, terephthalic anhydride, terephthaloyl difluoride, terephthaloyl dichloride, terephthaloyl dibromide, C₁-C₁₀-alkyl esters of terephthalic acid, C₁-C₁₀-alkenyl esters of terephthalic acid, isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid and C₁-C₁₀-alkenyl esters of isophthalic acid.

In a particularly preferred embodiment, component (a) consists essentially of at least one aromatic dicarboxylic compound of the general formula (I) selected from the group consisting of terephthalic acid, terephthalic anhydride, terephthaloyl difluoride, terephthaloyl dichloride, terephthaloyl dibromide, C₁-C₁₀-alkyl esters of terephthalic acid, C₁-C₁₀-alkenyl esters of terephthalic acid, isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid and C₁-C₁₀-alkenyl esters of isophthalic acid.

In the context of the present invention, the expression “consists essentially of” is understood to mean that component (a) comprises at least 99% by weight, preferably at least 99.5% by weight and particularly preferably at least 99.9% by weight of at least one aromatic dicarboxylic compound of the general formula (I) selected from the group consisting of terephthalic acid, terephthalic anhydride, terephthaloyl difluoride, terephthaloyl dichloride, terephthaloyl dibromide, C₁-C₁₀-alkyl esters of terephthalic acid, C₁-C₁₀-alkenyl esters of terephthalic acid, isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid and C₁-C₁₀-alkenyl esters of isophthalic acid, based on the total weight of component (a) in the reaction mixture (R_{G}).

In a further very particularly preferred embodiment, component (a) consists essentially of at least one aromatic dicarboxylic compound of the general formula (I) selected from terephthalic anhydride, terephthaloyl dichloride and C₁-C₁₀-alkenyl esters of terephthalic acid.

In a particularly preferred embodiment, component (a) is terephthaloyl dichloride.

### Component (b)

The reaction mixture (R_{G}) comprises at least one aromatic diamino compound of the general formula (IIa), (IIb), (IIc) and/or (IId) as component (b).

The expressions “component (b)”, “at least one aromatic diamino compound of the general formula (IIa), (IIb), (IIc) and/or (IId)” and “at least one aromatic diamino compound (IIa-d)” are used synonymously hereinafter.

The expression “at least one aromatic diamino compound of the general formula (IIa), (IIb), (IIc) and/or (IId)” refers here to exactly one aromatic diamino compound of the general formula (IIa), (IIb), (IIc) and/or (IId) and also to mixtures of two or more different aromatic diamino compounds of the general formula (IIa), (IIb), (IIc) and/or (IId). Suitable aromatic diamino compounds of the general formula (IIa), (IIb), (IIc) and/or (IId) are known in principle to those skilled in the art.

The at least one aromatic diamino compound (IIa-d) used in the method according to the invention comprises two amino groups. The designation “amino group” is understood in the context of the present invention to mean —NH₂. It is clear to those skilled in the art that amino groups can also be in protonated form as amino-hydrogen salts (—NH₃⁺Q⁻), wherein Q⁻ is an anion equivalent selected from the group consisting of fluoride (F⁻), chloride (Cl⁻), bromide (Br⁻), iodide(I⁻), hydrogensulfate (HSO₄⁻), sulfate (SO₄²⁻), methanesulfonate (H₃C—SO₃⁻), p-toluenesulfonate (p-H₃C—C₆H₄—SO₃⁻) and nitrate (NO₃⁻).

In the context of the present application, a person skilled in the art understands that “an anion equivalent” is an anion having a single negative charge or a charge equivalent of an anion having two or more negative charges.

The at least one aromatic diamino compound used in the method according to the invention has the general formula (IIa), (IIb), (IIc) and/or (IId):

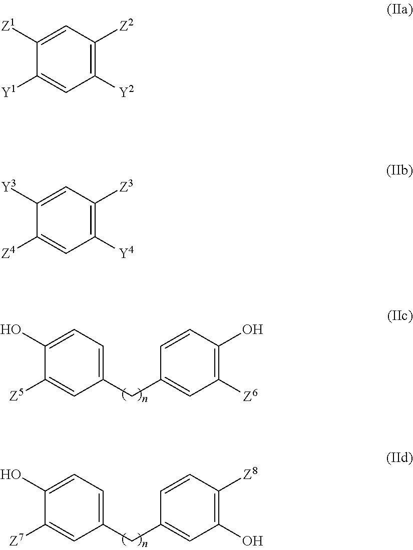

in which
n is 0 or 1
Y¹, Y², Y³, Y⁴ are each independently —H, —OR⁴ or —SR⁴,
wherein R⁴ is selected from the group consisting of —H, —C₁-C₁₀-alkyl, trimethylsilyl, triethylsilyl, tert-butyldimethylsilyl, acetyl and tert-butyloxycarbonyl, and
wherein at most one of the radicals Y¹ and Y² is —H, and
wherein at most one of the radicals Y³ and Y⁴ is —H;
Z¹, Z², Z³, Z⁴, Z⁵, Z⁶, Z⁷, Z⁸ are each independently —NH₂ or —NH₃⁺Q⁻,
wherein Q⁻ is an anion equivalent selected from the group consisting of F⁻, Cl⁻, Br⁻, I⁻, HSO₄⁻, SO₄²⁻, H₃C—SO₃⁻, p-H₃C—C₆H₄—SO₃⁻ and NO₃⁻.

Preferred C₁-C₁₀-alkyl groups comprise linear and branched, saturated alkyl groups having 1 to 10 carbon atoms. Particularly preferred C₁-C₁₀-alkyl groups here are C₁-C₆-alkyl groups such as methyl, ethyl, n-propyl, isopropyl, nbutyl, sec-butyl, 2- or 3-methylpentyl or longer-chain groups such as n-heptyl, n-octyl, n-nonyl or n-decyl and also branched isomers thereof.

In the at least one aromatic diamino compound of the general formula (IIa), (IIb), (IIc) and/or (IId), Y¹, Y², Y³ and Y⁴ are each independently preferably hydroxyl groups or thiol groups.

The designation “hydroxyl groups” is understood in the context of the present invention to mean —OH. In analogy thereto, “thiol groups” are understood to mean —SH in the context of the present invention.

In a particularly preferred embodiment, Y¹, Y², Y³ and Y⁴ in the at least one aromatic diamino compound of the general formula (IIa) and/or (IIb) are hydroxyl groups.

Z¹, Z², Z³, Z⁴, Z⁵, Z⁶, Z⁷ and Z⁸ are each independently amino groups (—NH₂) or amino-hydrogen salts (—NH₃⁺Q⁻). Z¹, Z², Z³, Z⁴, Z⁵, Z⁶, Z⁷ and Z⁸ in the at least one aromatic diamino compound of the general formula (IIa), (IIb), (IIc) and/or (IId) are preferably amino-hydrogen salts.

Component (b) is preferably selected from the group consisting of 4,6-diamino-1,3-dihydroxybenzene, 4,6-diamino-1,3-dithiobenzene, 4,6-diamino-3-hydroxy-1-thiobenzene, 2,5-diamino-1,4-dihydroxybenzene, 2,5-diamino-1,4-dithiobenzene, 2,5-diamino-4-hydroxy-1-thiobenzene, 4,6-diamino-1,3-dihydroxybenzene dihydrochloride, 4,6-diamino-1,3-dithiobenzene dihydrochloride, 4,6-diamino-3-hydroxy-1-thiobenzene dihydrochloride, 2,5-diamino-1,4-dihydroxybenzene dihydrochloride, 2,5-diamino-1,4-dithiobenzene dihydrochloride, 2,5-diamino-4-hydroxy-1-thiobenzene dihydrochloride, 3,3′-diamino-4,4′-dihydroxybiphenyl, 3,3′-diamino-4,4′-dihydroxybiphenyl dihydrochloride, 4,4′-diamino-3,3′-dihydroxybiphenyl, 4,4′-diamino-3,3′-dihydroxybiphenyl dihydrochloride, 3,3′-diamino-4,4′-dihydroxydiphenylmethane, 3,3′-diamino-4,4′-dihydroxydiphenylmethane dihydrochloride, 4,4′-diamino-3,3′-dihydroxydiphenylmethane and 4,4′-diamino-3,3′-dihydroxydiphenylmethane dihydrochloride.

Component (b) is particularly preferably selected from the group consisting of 4,6-diamino-1,3-dihydroxybenzene, 4,6-diamino-1,3-dihydroxybenzene dihydrochloride, 2,5-diamino-1,4-dihydroxybenzene and 2,5-diamino-1,4-dihydroxybenzene dihydrochloride.

In a preferred embodiment, component (b) comprises at least 80% by weight, particularly preferably at least 90% by weight and very particularly preferably at least 98% by weight of at least one aromatic diamino compound (IIa-d) selected from the group consisting of 4,6-diamino-1,3-dihydroxybenzene, 4,6-diamino-1,3-dihydroxybenzene dihydrochloride, 5-diamino-1,4-dihydroxybenzene and 2,5-diamino-1,4-dihydroxybenzene dihydrochloride, based on the total weight of component (b) in the reaction mixture (R_{G}). The weight data specified here with respect to component (b) refer in this case to the total weight of 4,6-diamino-1,3-dihydroxybenzene, 4,6-diamino-1,3-dihydroxybenzene dihydrochloride, 5-diamino-1,4-dihydroxybenzene and 2,5-diamino-1,4-dihydroxybenzene dihydrochloride used.

In a further particularly preferred embodiment, component (b) consists essentially of at least one aromatic diamino compound (IIa-d) selected from the group consisting of 4,6-diamino-1,3-dihydroxybenzene, 4,6-diamino-1,3-dihydroxybenzene dihydrochloride, 5-diamino-1,4-dihydroxybenzene and 2,5-diamino-1,4-dihydroxybenzene dihydrochloride. In the context of the present invention, the expression “consists essentially of” is understood to mean that component (b) comprises at least 99% by weight, preferably at least 99.5% by weight and particularly preferably at least 99.9% by weight of at least one aromatic diamino compound (IIa-d) selected from the group consisting of 4,6-diamino-1,3-dihydroxybenzene, 4,6-diamino-1,3-dihydroxybenzene dihydrochloride, 5-diamino-1,4-dihydroxybenzene and 2,5-diamino-1,4-dihydroxybenzene dihydrochloride, based on the total weight of component (b) in the reaction mixture (R_{G}).

In a particularly preferred embodiment, component (b) consists of at least one aromatic diamino compound (IIa-d) selected from the group consisting of 4,6-diamino-1,3-dihydroxybenzene, 4,6-diamino-1,3-dihydroxybenzene dihydrochloride, 5-diamino-1,4-dihydroxybenzene and 2,5-diamino-1,4-dihydroxybenzene dihydrochloride.

In these embodiments, particular preference is given to 4,6-diamino-1,3-dihydroxybenzene dihydrochloride and/or 2,5-diamino-1,4-dihydroxybenzene dihydrochloride as component (b).

### Component (c)

The reaction mixture (R_{G}) comprises at least one ionic liquid (IL) as component (c).

The expressions “component (c)” and “at least one ionic liquid (IL)” are used synonymously hereinafter.

The expression “at least one ionic liquid (IL)” refers here to exactly one ionic liquid (IL) and also to mixtures of two or more different ionic liquids (IL). Suitable ionic liquids (IL) are known in principle to those skilled in the art.

Ionic liquids in the context of the present invention are understood to mean compounds having at least one cationic center and at least one anionic center, in particular which have at least one cation and at least one anion, in which at least one of the ions, in particular the cation, is organic.

Ionic liquids, according to the definition of Wasserscheid and Keim in: Angewandte Chemie, 112, 3926-3945 (2000), are salts having non-molecular ionic character that melt at relatively low temperatures. They are liquid, with a relatively low viscosity, at relatively low temperatures. They have very good solvent capabilities for a large number of organic, inorganic and polymeric substances. They are also generally noncombustible, noncorrosive and have no measurable vapor pressure.

Ionic liquids are compounds which are formed by positive and negative ions, but have no overall charge. The positive as well as the negative ions are predominantly monovalent, but multivalent anions and/or cations, for example ions having one to five, preferably one to four, more preferably one to three and especially preferably one or two electric charges per ion, are also possible. The charges can be situated on various localized or delocalized regions within a molecule, i.e., in betaine-like fashion, or else be distributed like a separate anion and cation. Preference is given to ionic liquids constructed of at least one cation and at least one anion.

The invention is not restricted to specific ionic liquids; it is possible to use all suitable ionic liquids known to those skilled in the art.

The at least one ionic liquid (IL) preferably has a melting point which is as low as possible. The melting point of the at least one ionic liquid (IL) is preferably below 150° C., particularly preferably below 100° C. and very particularly preferably below 80° C.

The at least one ionic liquid (IL) preferably has the general formula (II):

[C]ₙ⁺[A]ⁿ⁻ (III)

in which
n=1, 2, 3 or 4;
the cation [C]ₙ⁺ is at least one cation selected from the group consisting of unsubstituted or at least monosubstituted imidazolium cations, imidazolinium cations, imidazolidinium cations, quaternary ammonium cations, quaternary phosphonium cations, pyrazolium cations, pyrazolinium cations, pyridinium cations, pyridazinium cations, pyrimidinium cations, pyrazinium cations, pyrrolidinium cations, guanidinium cations, thiazolium cations, oxazolium cations, triazolium cations, the 1,8-diazabicyclo[5.4.0]undec-7-enium cation, the 1,8-diazabicyclo[4.3.0]non-5-enium cation and oligomers or polymers comprising these cations, wherein the substituents are selected from the group consisting of linear or branched —C₁-C₁₈-alkyl, —C₅-C₁₂-cycloalkyl and —C₆-C₁₄-aryl;
the anion [A]ⁿ⁻ is selected from the group consisting of halide-containing anions, cyanide, thiocyanate, cyanate, isocyanate, nitrite, nitrate, unsubstituted or at least monosubstituted sulfates, sulfites, sulfonates, carboxylates, borates, boronates, carbonates, carbonate esters, amides, carboximidates, sulfonyl imidates, bis(sulfonyl) imidates, alkoxides and aryl oxides,
wherein the substituents are selected from the group consisting of linear or branched —C₁-C₁₈-alkyl, —C₅-C₁₂-cycloalkyl and —C₆-C₁₄-aryl.

The expression “at least one cation” refers here not only to precisely one cation but also to mixed species of two or more cations such as

[C¹]⁺[C²]⁺2[A]⁻,[C¹]⁺[C²]⁺[A]²⁻, [C¹]⁺[C²]⁺[C³]⁺[A]³⁻ or [C¹]⁺[C²]⁺[C³]⁺[C⁴]⁺[A]⁴⁻

where C¹, C², C₃ and C₄ are each independently selected from the groups specified for [C]ₙ⁺.

In addition, mixed species with metal cations can also be used, such as [C¹]⁺[C²]⁺[C³]⁺[M¹]⁺[A]⁴⁻, [C¹]⁺[C²]⁺[M¹]⁺[M²]⁺[A]⁴⁻, [C¹]⁺[M¹]⁺[M²]⁺[M³]⁺[A]⁴⁻, [C¹]⁺[C²]⁺[M¹]⁺[A]³⁻, [C¹]⁺[M¹]⁺[M²]⁺[A]³⁻, [C¹]⁺[M¹]⁺[A]²⁻, [C¹]⁺[M¹]⁺2 [A]⁻, [C¹]⁺[C²]⁺[M⁴]²⁺[A]⁴⁻, [C¹]⁺[M¹]⁺[M⁴]²⁺[A]⁴⁻, [C¹]⁺[M⁵]³⁺[A]⁴⁻, [C¹]⁺[M⁴]²⁺[A]³⁻ where M¹, M², M³ are monovalent metal cations, M⁴ is divalent metal cations and M⁵ is trivalent metal cations.

The cation [C]ₙ⁺ is preferably at least one unsubstituted or at least monosubstituted cation selected from the group consisting of
imidazolium cations of the general formula (IV)

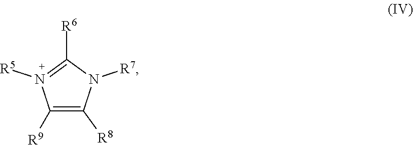

and also all isomeric imidazolinium cations and imidazolidinium cations analogous to the formula above,
quaternary ammonium cations of the general formula (V)

[NR⁵R⁶R⁷R⁸]⁺ (V),
quaternary phosphonium cations of the general formula (VI)

[PR⁵R⁶R⁷R⁸]⁺ (VI),
H-pyrazolium cations of the general formula (VII)

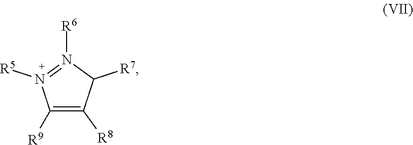

and also 3H-pyrazolium cations, 4H-pyrazolium cations, 1-pyrazolinium cations, 2-pyrazolinium cations and 3-pyrazolinium cations,
pyridinium cations of the general formula (VIII)

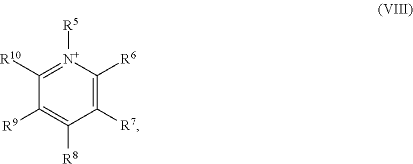

and also pyridazinium, pyrimidinium and pyrazinium ions,
pyrrolidinium cations of the general formula (IX)

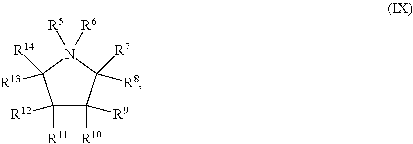

guanidinium cations of the general formula (X)

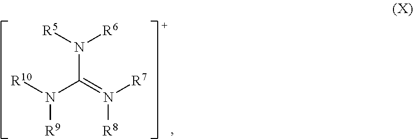

five- to six-membered heterocyclic cations comprising at least one phosphorus or nitrogen atom and also optionally an oxygen or a sulfur atom such as, for example, thiazolium, oxazolium, 1,2,4-triazolium or 1,2,3-triazolium cations, particularly preferably those compounds comprising at least one five- to six-membered heterocycle comprising one, two or three nitrogen atoms and one oxygen or one sulfur atom, very particularly preferably those having one or two nitrogen atoms,
the 1,8-diazabicyclo[5.4.0]undec-7-enium cation and the 1,8-diazabicyclo[4.3.0]non-5-enium cation of the general formula (XI)

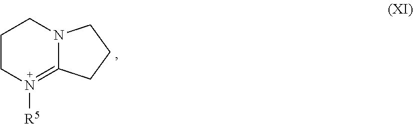

and also oligomers and polymers comprising these cations, where R⁵, R⁶, R⁷, R⁸, R⁹ R¹⁰, R¹¹, R¹², R¹³ and R¹⁴ are each independently selected from the group consisting of —H, —C₁-C₁₈-alkyl, —C₅-C₁₂-cycloalkyl and —C₆-C₁₄-aryl.

It is clear to a person skilled in the art that the general formulae (IV), (VII), (VIII) and (X) are in each case a possible mesomeric resonance structure of the relevant cation and the positive charge is delocalized over several mesomeric resonance structures.

For the radicals R⁵, R⁶, R⁷, R⁸, R⁹, R¹⁰, R¹¹, R¹², R¹³ and R¹⁴ in the general formulae (IV) to (XI), preferred C₁-C₁₈-alkyl groups include linear and branched saturated alkyl groups having 1 to 18 carbon atoms, which are optionally interrupted by one or more oxygen and/or sulfur atoms and/or one or more unsubstituted or at least monosubstituted imino groups, in which the C₁-C₁₈-alkyl groups may optionally be substituted by functional groups and/or halogen groups.

The number of oxygen and/or sulfur atoms and/or imino groups is not restricted. Generally, it amounts to not more than 5 in the radical, preferably not more than 4 and very particularly preferably not more than 3. There is moreover generally at least one carbon atom, preferably at least two carbon atoms, between two heteroatoms.

Unsubstituted or at least monosubstituted imino groups may be, for example, imino, methylimino, isopropylimino, n-butylimino or tert-butylimino.

Preferred functional groups include for example carboxy, carboxamide, hydroxyl, di(C₁-C₄-alkyl)amino, C₁-C₄-alkyloxycarbonyl, cyano or C₁-C₄-alkyloxy.

Preferred C₁-C₁₈-alkyl groups comprise for example C₁-C₄-alkyl groups such as methyl, ethyl, n-propyl, isopropyl, n-butyl, sec-butyl, tert-butyl or longer-chain alkyl groups such as n-pentyl, n-heptyl, n-octyl, n-nonyl, n-decyl, n-dodecyl, n-tetradecyl, n-hexadecyl or n-octadecyl and branched isomers thereof.

Further preferred C₁-C₁₀-alkyl groups, substituted by functional groups and/or halogen groups, comprise for example 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, 2-butoxyethyl, diethoxymethyl, diethoxyethyl, 2-isopropoxyethyl, 2-butoxypropyl, chloromethyl, 2-chloroethyl, trichloromethyl, trifluoromethyl, 1,1-dimethyl-2-chloroethyl, 2-methoxyisopropyl, 2-ethoxyethyl, 2,2,2-trifluoroethyl, 2-hydroxyethyl, 2-hydroxypropyl, 3-hydroxypropyl, 4-hydroxybutyl, 6-hydroxyhexyl or 2-hydroxy-2,2-dimethylethyl.

Further preferred C₁-C₁₀-alkyl groups, which are interrupted by one or more oxygen and/or sulfur atoms and/or one or more unsubstituted or at least monosubstituted imino groups, comprise for example butylthiomethyl, 2-dodecylthioethyl, 2-phenylthioethyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

For the radicals R⁵, R⁶, R⁷, R⁸, R⁹, R¹⁰, R¹¹, R¹², R¹³ and R¹⁴ in the general formulae (IV) to (XI), preferred C₅-C₁₂-cycloalkyl groups include unsubstituted or at least monosubstituted saturated cycloalkyl groups having 5 to 12 carbon atoms, which are optionally interrupted by one or more oxygen and/or sulfur atoms and/or one or more unsubstituted or at least monosubstituted imino groups, in which the C₅-C₁₂-cycloalkyl groups may optionally be substituted by functional groups and/or halogen groups.

Preferred C₅-C₁₂-cycloalkyl groups include, for example, cyclopentyl, cyclohexyl, cycloheptyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, 1,3-dioxolan-2-yl, 2-methyl-1,3-dioxolan-2-yl, 4-methyl-1,3-dioxolan-2-yl or norbornyl.

For the radicals R⁵, R⁶, R⁷, R⁸, R⁹, R¹⁰, R¹¹, R¹², R¹³ and R¹⁴ in the general formulae (IV) to (XI), preferred C₆-C₁₄-aryl groups include unsubstituted or at least monosubstituted aryl groups having 6 to 14 carbon atoms, in which the C₆-C₁₄-aryl groups may optionally be substituted by functional groups and/or halogen groups.

Preferred C₆-C₁₄-aryl groups comprise, for example, phenyl, tolyl, xylyl, benzyl, α-naphthyl, 4-diphenylyl, chlorophenyl, dichlorophenyl, trichlorophenyl, difluorophenyl, p-chlorobenzyl, 2,4-dichlorobenzyl, methylphenyl, dimethylphenyl, trimethylphenyl, ethylphenyl, diethylphenyl, isopropylphenyl, tert-butylphenyl, 1-phenylethyl, 2-phenylethyl, α,α-dimethylbenzyl, benzhydryl, p-tolylmethyl, 1-(p-butylphenyl)ethyl, dodecylphenyl, methoxyphenyl, dimethoxyphenyl, ethoxyphenyl, hexyloxyphenyl, p-methoxybenzyl, m-ethoxybenzyl, 2-phenoxyethyl, 2-phenoxypropyl, 3-phenoxypropyl, 4-phenoxybutyl, 6-phenoxyhexyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl or ethoxymethylphenyl.

Preferably, R⁵, R⁶, R⁷, R⁸, R⁹, R¹⁰, R¹¹, R¹², R¹³ and R¹⁴ are each independently selected from the group consisting of —H, methyl, ethyl, n-propyl, isopropyl, n-butyl, tert-butyl, n-pentyl, n-hexyl, 2-hydroxyethyl, 2-cyanoethyl, 2-(methoxycarbonyl)ethyl, 2-(ethoxycarbonyl)ethyl, 2-(n-butoxycarbonyl)ethyl, benzyl, acetyl, dimethylamino, diethylamino and chlorine.

The at least one ionic liquid (IL) particularly preferably comprises at least one imidazolium cation of the general formula (IV) as cation [C]ₙ⁺:

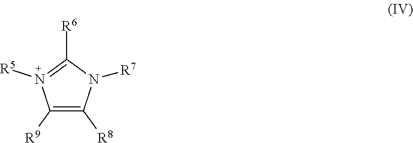

in which
R⁵, R⁶, R⁷, R⁸, R⁹ are each independently selected from the group consisting of —H, linear or branched —C₁-C₁₈-alkyl, —C₅-C₁₂-cycloalkyl and —C₆-C₁₄-aryl.

The cation [C]ₙ⁺ is preferably at least one cation selected from the group consisting of 1-methylimidazolium, 1-methyl-2-ethylimidazolium, 1-methyl-3-octylimidazolium, 1,2-dimethylimidazolium, 1,3-dimethylimidazolium, 2,3-dimethylimidazolium, 3,4-dimethylimidazolium, 1,2,3-trimethylimidazolium, 1,3,4-trimethylimidazolium, 1,3,4,5-tetramethylimidazolium, 1-ethylimidazolium, 1-ethyl-2-methylimidazolium, 1-ethyl-3-methylimidazolium, 1-ethyl-2,3-dimethylimidazolium, 2-ethyl-3,4-dimethylimidazolium, 1-propylimidazolium, 1-propyl-2-methylimidazolium, 1-propyl-3-methylimidazolium, 1-propyl-2,3-dimethylimidazolium, 1,3-dipropylimidazolium, 1-butylimidazolium, 1-butyl-2-methylimidazolium, 1-butyl-3-methylimidazolium, 1-butyl-4-methylimidazolium, 1-butyl-2,3-dimethylimidazolium, 1-butyl-3,4-dimethylimidazolium, 1-butyl-3,4,5-trimethylimidazolium, 1-butyl-2-ethylimidazolium, 1-butyl-3-ethyl-imidazolium, 1-butyl-2-ethyl-5-methylimidazolium, 1,3-dibutylimidazolium, 1,3-dibutyl-2-methylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-2-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium and 1-benzyl-3-methylimidazolium.

The present application therefore further relates to a method, characterized in that the cation [C]ₙ⁺ is at least one cation selected from the group consisting of 1-methylimidazolium, 1-methyl-2-ethylimidazolium, 1-methyl-3-octylimidazolium, 1,2-dimethylimidazolium, 1,3-dimethylimidazolium, 2,3-dimethylimidazolium, 3,4-dimethylimidazolium, 1,2,3-trimethylimidazolium, 1,3,4-trimethylimidazolium, 1,3,4,5-tetramethylimidazolium, 1-ethylimidazolium, 1-ethyl-2-methylimidazolium, 1-ethyl-3-methylimidazolium, 1-ethyl-2,3-dimethylimidazolium, 2-ethyl-3,4-dimethylimidazolium, 1-propylimidazolium, 1-propyl-2-methylimidazolium, 1-propyl-3-methylimidazolium, 1-propyl-2,3-dimethylimidazolium, 1,3-dipropylimidazolium, 1-butylimidazolium, 1-butyl-2-methylimidazolium, 1-butyl-3-methylimidazolium, 1-butyl-4-methylimidazolium, 1-butyl-2,3-dimethylimidazolium, 1-butyl-3,4-dimethylimidazolium, 1-butyl-3,4,5-trimethylimidazolium, 1-butyl-2-ethylimidazolium, 1-butyl-3-ethyl-imidazolium, 1-butyl-2-ethyl-5-methylimidazolium, 1,3-dibutylimidazolium, 1,3-dibutyl-2-methylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-2-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium and 1-benzyl-3-methylimidazolium.

The cation [C]ₙ⁺ is particularly preferably at least one cation selected from the group consisting of 1-methylimidazolium, 1,2-dimethylimidazolium, 1,2,3-trimethylimidazolium, 1-methyl-2-ethylimidazolium, 1-ethylimidazolium, 1-ethyl-2-methylimidazolium, 1-ethyl-2,3-dimethylimidazolium, 1-ethyl-3-methylimidazolium, 1,3-diethylimidazolium, 1-propylimidazolium, 1-propyl-3-methylimidazolium, 1-butylimidazolium, 1-butyl-2-methylimidazolium, 1butyl-3-methylimidazolium, 1-butyl-2,3-dimethylimidazolium, 1,3-dibutylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-3-methylimidazolium, 1-decyl-3-methylimidazolium, 1-dodecyl-3-methylimidazolium and 1-benzyl-3-methylimidazolium.

The cation [C]ₙ⁺ is very particularly preferably at least one cation selected from the group consisting of 1-methylimidazolium, 1,2-dimethylimidazolium, 1,2,3-trimethylimidazolium, 1-ethylimidazolium, 1-ethyl-2-methylimidazolium, 1-ethyl-2,3-dimethylimidazolium, 1-ethyl-3-methylimidazolium, 1,3-diethylimidazolium, 1-butylimidazolium, 1-butyl-2-methylimidazolium, 1-butyl-3-methylimidazolium and 1-butyl-2,3-dimethylimidazolium, 1,3-dibutylimidazolium.

As anions, it is in principle possible to use all anions.

The anion [A]ⁿ⁻ is preferably selected from the group consisting of
the group of halogen-containing anions such as:
   F⁻, Cl⁻, Br⁻, I⁻, BF₄⁻, BCl₄⁻, PF₆⁻, AsF₆⁻, SbF₆⁻, AlCl₄⁻, Al₂Cl₇⁻, AlBr₄⁻, Al₂Br₇⁻, ZnCl₃⁻, SnCl₃⁻, FeCl₄⁻,
the group consisting of cyanide, thiocyanate, cyanate and isocyanate:
   CN⁻, SCN⁻, OCN⁻, NCO⁻,
the group consisting of nitrite and nitrate:
   NO₂⁻, NO₃⁻
the group of the sulfates, sulfites or sulfonates of the general formulae:
   SO₄²⁻, HSO₄⁻, SO₃²⁻, HSO₃⁻, R^{a}OSO₃⁻, R^{a}SO₃⁻,
   the group of the carboxylates of the general formula:
   R^{a}COO⁻,
the group of the borates of the general formulae:
   BO₃³⁻, HBO₃²⁻, H₂BO₃⁻, R^{a}R^{b}BO₃⁻, R^{a}HBO₃⁻, R^{a}BO₃²⁻,
the group of the boronates of the general formulae:
   R^{a}BO₂²⁻, R^{a}R^{b}BO⁻,
the group of the carbonates or carbonic esters of the general formulae:
   HCO₃⁻, CO₃²⁻, R^{a}CO₃⁻,
the group of the amides of the general formulae:
   H₂N⁻, R^{a}NH⁻, R^{a}R^{b}N⁻,
the group of the carboximidates, bis(sulfonyl)imidates or sulfonylimidates of the general formulae:

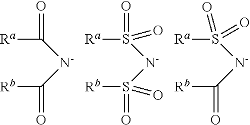

the group of the alkoxides or aryl oxides of the general formula:
   R^{a}O⁻,
   where R^{a} and R^{b} are each independently selected from the group consisting of —H, —C₁-C₁₀-alkyl, —C₅-C₁₂-cycloalkyl and —C₆-C₁₄-aryl.

For the radicals R^{a} and R^{b}, preferred C₁-C₁₈-alkyl groups include linear and branched saturated alkyl groups having 1 to 18 carbon atoms, which are optionally interrupted by one or more oxygen and/or sulfur atoms and/or one or more unsubstituted or at least monosubstituted imino groups, in which the C₁-C₁₈-alkyl groups may optionally be substituted by functional groups and/or halogen groups.

The number of oxygen and/or sulfur atoms and/or imino groups is not restricted. Generally, it amounts to not more than 5 in the radical, preferably not more than 4 and very particularly preferably not more than 3. There is moreover generally at least one carbon atom, preferably at least two carbon atoms, between two heteroatoms.

Unsubstituted or at least monosubstituted imino groups may be, for example, imino, methylimino, isopropylimino, n-butylimino or tert-butylimino.

Preferred functional groups include for example carboxy, carboxamide, hydroxyl, di(C₁-C₄-alkyl)amino, C₁-C₄-alkyloxycarbonyl, cyano or C₁-C₄-alkyloxy.

Preferred C₁-C₁₈-alkyl groups comprise for example C₁-C₄-alkyl groups such as methyl, ethyl, n-propyl, isopropyl, n-butyl, sec-butyl, tert-butyl or longer-chain alkyl groups such as n-pentyl, n-heptyl, n-octyl, n-nonyl, n-decyl, n-dodecyl, n-tetradecyl, n-hexadecyl or n-octadecyl and branched isomers thereof.

Further preferred C₁-C₁₈-alkyl groups, substituted by functional groups and/or halogen groups, comprise for example 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, 2-butoxyethyl, diethoxymethyl, diethoxyethyl, 2-isopropoxyethyl, 2-butoxypropyl, chloromethyl, 2-chloroethyl, trichloromethyl, trifluoromethyl, 1,1-dimethyl-2-chloroethyl, 2-methoxyisopropyl, 2-ethoxyethyl, 2,2,2-trifluoroethyl, 2-hydroxyethyl, 2-hydroxypropyl, 3-hydroxypropyl, 4-hydroxybutyl, 6-hydroxyhexyl or 2-hydroxy-2,2-dimethylethyl.

Further preferred C₁-C₁₀-alkyl groups, which are interrupted by one or more oxygen and/or sulfur atoms and/or one or more unsubstituted or at least monosubstituted imino groups, comprise for example butylthiomethyl, 2-dodecylthioethyl, 2-phenylthioethyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

For the radicals R^{a} and R^{b}, preferred C₅-C₁₂-cycloalkyl groups comprise unsubstituted or at least monosubstituted saturated cycloalkyl groups having 5 to 12 carbon atoms, which are optionally interrupted by one or more oxygen and/or sulfur atoms and/or one or more unsubstituted or at least monosubstituted imino groups, in which the C₅-C₁₂-cycloalkyl groups may optionally be substituted by functional groups and/or halogen groups.

Preferred C₅-C₁₂-cycloalkyl groups include, for example, cyclopentyl, cyclohexyl, cycloheptyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, 1,3-dioxolan-2-yl, 2-methyl-1,3-dioxolan-2-yl, 4-methyl-1,3-dioxolan-2-yl or norbornyl.

For the radicals R^{a} and R^{b}, preferred C₆-C₁₄-aryl groups include unsubstituted or at least monosubstituted aryl groups having 6 to 14 carbon atoms, in which the C₆-C₁₄-aryl groups may optionally be substituted by functional groups and/or halogen groups.

Preferred C₆-C₁₄-aryl groups comprise, for example, phenyl, tolyl, xylyl, benzyl, α-naphthyl, 4-diphenylyl, chlorophenyl, dichlorophenyl, trichlorophenyl, difluorophenyl, p-chlorobenzyl, 2,4-dichlorobenzyl, methylphenyl, dimethylphenyl, trimethylphenyl, ethylphenyl, diethylphenyl, isopropylphenyl, tert-butylphenyl, 1-phenylethyl, 2-phenylethyl, α,α-dimethylbenzyl, benzhydryl, p-tolylmethyl, 1-(p-butylphenyl)ethyl, dodecylphenyl, methoxyphenyl, dimethoxyphenyl, ethoxyphenyl, hexyloxyphenyl, p-methoxybenzyl, m-ethoxybenzyl, 2-phenoxyethyl, 2-phenoxypropyl, 3-phenoxypropyl, 4-phenoxybutyl, 6-phenoxyhexyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl or ethoxymethylphenyl.

R^{a} and R^{b} are preferably each independently selected from the group consisting of —H, methyl, ethyl, n-propyl, isopropyl, n-butyl, tert-butyl, n-pentyl, n-hexyl, 2-hydroxyethyl, 2-cyanoethyl, 2-(methoxycarbonyl)ethyl, 2-(ethoxycarbonyl)ethyl, 2-(n-butoxycarbonyl)ethyl, benzyl, acetyl, dimethylamino, diethylamino and chlorine.

The anion [A]ⁿ⁻ is preferably selected from the group consisting of fluoride, chloride, bromide, iodide, tetrachloroaluminate, heptachlorodialuminate, tetrabromoaluminate, heptabromodialuminate, trichlorozincate, thiocyanate, nitrite, nitrate, sulfate, hydrogensulfate, methylsulfate, ethylsulfate, sulfite, hydrogensulfite, methanesulfonate, trifluoromethanesulfonate, ethanesulfonate, tosylate, decylbenzenesulfonate, didecylbenzenesulfonate, dodecylbenzenesulfonate, didodecylbenzenesulfonate, bis(trifluoromethanesulfonyl)methane, acetate, trifluoroacetate, borate, tetracyanoborate, bis(oxalato)borate, bis(malonato)borate, bis(phtalato)borate, bis(salicylato)borate, tetrakis(hydrogensulfato)borate, tetrakis(methylsulfonato)borate, carbonate, methylcarbonate, hydrogencarbonate, dicyanamide, bis(trifluoromethyl)imidate and bis(trifluoromethanesulfonyl)imidate.

The anion [A]ⁿ⁻ is particularly preferably selected from the group consisting of chloride, tetrachloroaluminate, heptachlorodialuminate, trichlorozincate, sulfate, hydrogensulfate, methylsulfate, ethylsulfate, methanesulfonate, trifluoromethanesulfonate, ethanesulfonate, tosylate, decylbenzenesulfonate, didecylbenzenesulfonate, dodecylbenzenesulfonate, didodecylbenzenesulfonate, acetate, carbonate, methylcarbonate and hydrogencarbonate.

The anion [A]ⁿ⁻ is particularly preferably selected from the group consisting of chloride and tetrachloroaluminate.

The at least one ionic liquid (IL) is preferably selected from the group consisting of 1-methylimidazolium chloride, 1,2-dimethylimidazolium chloride, 1,3-dimethylimidazolium chloride, 1,2,3-trimethylimidazolium chloride, 1-ethylimidazolium chloride, 1-ethyl-2-methylimidazolium chloride, 1-ethyl-3-methylimidazolium chloride, 1-ethyl-2,3-dimethylimidazolium chloride, 1,3-diethylimidazolium chloride, 1-butylimidazolium chloride, 1-butyl-2-methylimidazolium chloride, 1-butyl-3-methylimidazolium chloride, 1-butyl-2,3-dimethylimidazolium chloride, 1,3-dibutylimidazolium chloride, 1-methylimidazolium tetrachloroaluminate, 1,2-dimethylimidazolium tetrachloroaluminate, 1,3-dimethylimidazolium tetrachloroaluminate, 1,2,3-trimethylimidazolium tetrachloroaluminate, 1-ethyl tetrachloroaluminate, 1-ethyl-2-methyl tetrachloroaluminate, 1-ethyl-3-methylimidazolium tetrachloroaluminate, 1-ethyl-2,3-dimethylimidazolium tetrachloroaluminate, 1,3-diethylimidazolium tetrachloroaluminate, 1-butylimidazolium tetrachloroaluminate, 1-butyl-2-methylimidazolium tetrachloroaluminate, 1-butyl-3-methylimidazolium tetrachloroaluminate, 1-butyl-2,3-dimethylimidazolium tetrachloroaluminate, 1,3-dibutylimidazolium tetrachloroaluminate, 1-methylimidazolium sulfate, 1,2-dimethylimidazolium sulfate, 1,3-dimethylimidazolium sulfate, 1,2,3-trimethylimidazolium sulfate, 1-ethylimidazolium sulfate, 1-ethyl-2-methylimidazolium sulfate, 1-ethyl-3-methylimidazolium sulfate, 1-ethyl-2,3-dimethylimidazolium sulfate, 1,3-diethylimidazolium sulfate, 1-butylimidazolium sulfate, 1-butyl-2-methylimidazolium sulfate, 1-butyl-3-methylimidazolium sulfate, 1-butyl-2,3-dimethylimidazolium sulfate, 1,3-dibutylimidazolium sulfate, 1-methylimidazolium hydrogensulfate, 1,2-dimethylimidazolium hydrogensulfate, 1,3-dimethylimidazolium hydrogensulfate, 1,2,3-trimethylimidazolium hydrogensulfate, 1-ethylimidazolium hydrogensulfate, 1-ethyl-2-methylimidazolium hydrogensulfate, 1-ethyl-3-methylimidazolium hydrogensulfate, 1-ethyl-2,3-dimethylimidazolium hydrogensulfate, 1,3-diethylimidazolium hydrogensulfate, 1-butylimidazolium hydrogensulfate, 1-butyl-2-methylimidazolium hydrogensulfate, 1-butyl-3-methylimidazolium hydrogensulfate, 1-butyl-2,3-dimethylimidazolium hydrogensulfate, 1,3-dibutylimidazolium hydrogensulfate, 1-methylimidazolium methylsulfate, 1,2-dimethylimidazolium methylsulfate, 1,3-dimethylimidazolium methylsulfate, 1,2,3-trimethylimidazolium methylsulfate, 1-ethylimidazolium methylsulfate, 1-ethyl-2-methylimidazolium methylsulfate, 1-ethyl-3-methylimidazolium methylsulfate, 1-ethyl-2,3-dimethylimidazolium methylsulfate, 1,3-diethylimidazolium methylsulfate, 1-butylimidazolium methylsulfate, 1-butyl-2-methylimidazolium methylsulfate, 1-butyl-3-methylimidazolium methylsulfate, 1-butyl-2,3-dimethylimidazolium methylsulfate, 1,3-dibutylimidazolium methylsulfate, 1-methylimidazolium ethylsulfate, 1,2-dimethylimidazolium ethylsulfate, 1,3-dimethylimidazolium ethylsulfate, 1,2,3-trimethylimidazolium ethylsulfate, 1-ethylimidazolium ethylsulfate, 1-ethyl-2-methylimidazolium ethylsulfate, 1-ethyl-3-methylimidazolium ethylsulfate, 1-ethyl-2,3-dimethylimidazolium ethylsulfate, 1,3-diethylimidazolium ethylsulfate, 1-butylimidazolium ethylsulfate, 1-butyl-2-methylimidazolium ethylsulfate, 1-butyl-3-methylimidazolium ethylsulfate, 1-butyl-2,3-dimethylimidazolium ethylsulfate, 1,3-dibutylimidazolium ethylsulfate, 1-methylimidazolium methanesulfonate, 1,2-dimethylimidazolium methanesulfonate, 1,3-dimethylimidazolium methanesulfonate, 1,2,3-trimethylimidazolium methanesulfonate, 1-ethylimidazolium methanesulfonate, 1-ethyl-2-methylimidazolium methanesulfonate, 1-ethyl-3-methylimidazolium methanesulfonate, 1-ethyl-2,3-dimethylimidazolium methanesulfonate, 1,3-diethylimidazolium methanesulfonate, 1-butylimidazolium methanesulfonate, 1-butyl-2-methylimidazolium methanesulfonate, 1-butyl-3-methylimidazolium methanesulfonate, 1-butyl-2,3-dimethylimidazolium methanesulfonate, 1,3-dibutylimidazolium methanesulfonate, 1-methylimidazolium trifluoromethanesulfonate, 1,2-dimethylimidazolium trifluoromethanesulfonate, 1,3-dimethylimidazolium trifluoromethanesulfonate, 1,3-dimethylimidazolium trifluoromethanesulfonate, 1,2,3-trimethylimidazolium trifluoromethanesulfonate, 1-ethylimidazolium trifluoromethanesulfonate, 1-ethyl-2-methylimidazolium trifluoromethanesulfonate, 1-ethyl-3-methylimidazolium trifluoromethanesulfonate, 1-ethyl-2,3-dimethylimidazolium trifluoromethanesulfonate, 1,3-diethylimidazolium trifluoromethanesulfonate, 1-butylimidazolium trifluoromethanesulfonate, 1-butyl-2-methylimidazolium trifluoromethanesulfonate, 1-butyl-3-methylimidazolium trifluoromethanesulfonate, 1-butyl-2,3-dimethylimidazolium trifluoromethanesulfonate, 1,3-dibutylimidazolium trifluoromethanesulfonate, 1-methylimidazolium tosylate, 1,2-dimethylimidazolium tosylate, 1,3-dimethylimidazolium tosylate, 1,2,3-trimethylimidazolium tosylate, 1-ethylimidazolium tosylate, 1-ethyl-2-methylimidazolium tosylate, 1-ethyl-3-methylimidazolium tosylate, 1-ethyl-2,3-dimethylimidazolium tosylate, 1,3-diethylimidazolium tosylate, 1-butylimidazolium tosylate, 1-butyl-2-methylimidazolium tosylate, 1-butyl-3-methylimidazolium tosylate, 1-butyl-2,3-dimethylimidazolium tosylate, 1,3-dibutylimidazolium tosylate, 1-methylimidazolium acetate, 1,2-dimethylimidazolium acetate, 1,3-dimethylimidazolium acetate, 1,2,3-trimethylimidazolium acetate, 1-ethylimidazolium acetate, 1-ethyl-2-methylimidazolium acetate, 1-ethyl-3-methylimidazolium acetate, 1-ethyl-2,3-dimethylimidazolium acetate, 1,3-diethylimidazolium acetate, 1-butylimidazolium acetate, 1-butyl-2-methylimidazolium acetate, 1-butyl-3-methylimidazolium acetate, 1-butyl-2,3-dimethylimidazolium acetate, 1,3-dibutylimidazolium acetate, 1-methylimidazolium methylcarbonate, 1,2-dimethylimidazolium methylcarbonate, 1,3-dimethylimidazolium methylcarbonate, 1,2,3-trimethylimidazolium methylcarbonate, 1-ethylimidazolium methylcarbonate, 1-ethyl-2-methylimidazolium methylcarbonate, 1-ethyl-3-methylimidazolium methylcarbonate, 1-ethyl-2,3-dimethylimidazolium methylcarbonate, 1,3-diethylimidazolium methylcarbonate, 1-butylimidazolium methylcarbonate, 1-butyl-2-methylimidazolium carbonate, 1-butyl-3-methylimidazolium methylcarbonate, 1-butyl-2,3-dimethylimidazolium methylcarbonate, 1,3-dibutylimidazolium methylcarbonate, 1-methylimidazolium hydrogencarbonate, 1,2-dimethylimidazolium hydrogencarbonate, 1,3-dimethylimidazolium hydrogencarbonate, 1,2,3-trimethylimidazolium hydrogencarbonate, 1-ethylimidazolium hydrogencarbonate, 1-ethyl-2-methylimidazolium hydrogencarbonate, 1-ethyl-3-methylimidazolium hydrogencarbonate, 1-ethyl-2,3-dimethylimidazolium hydrogencarbonate, 1,3-diethylimidazolium hydrogencarbonate, 1-butylimidazolium hydrogencarbonate, 1-butyl-2-methylimidazolium hydrogencarbonate, 1-butyl-3-methylimidazolium hydrogencarbonate, 1-butyl-2,3-dimethylimidazolium hydrogencarbonate and 1,3-dibutylimidazolium hydrogencarbonate.

The at least one ionic liquid (IL) is particularly preferably selected from the group consisting of 1-methylimidazolium chloride, 1,3-dimethylimidazolium chloride, 1-ethylimidazolium chloride, 1-ethyl-3-methylimidazolium chloride, 1-ethyl-2,3-dimethylimidazolium chloride, 1,3-diethylimidazolium chloride, 1-butylimidazolium chloride, 1-butyl-3-methylimidazolium chloride, 1-butyl-2,3-dimethylimidazolium chloride, 1,3-dibutylimidazolium chloride, 1-methylimidazolium tetrachloroaluminate, 1,3-dimethylimidazolium tetrachloroaluminate, 1-ethylimidazolium tetrachloroaluminate, 1-ethyl-3-methylimidazolium tetrachloroaluminate, 1-ethyl-2,3-dimethylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1-butyl-2,3-dimethylimidazolium tetrachloroaluminate, 1,3-dibutylimidazolium tetrachloroaluminate, 1-methylimidazolium hydrogensulfate, 1,3-dimethylimidazolium hydrogensulfate, 1-ethylimidazolium hydrogensulfate, 1-ethyl-3-methylimidazolium hydrogensulfate, 1-ethyl-2,3-dimethylimidazolium hydrogensulfate, 1,3-diethylimidazolium hydrogensulfate, 1-butylimidazolium hydrogensulfate, 1-butyl-3-methylimidazolium hydrogensulfate, 1-butyl-2,3-dimethylimidazolium hydrogensulfate, 1,3-dibutylimidazolium hydrogensulfate, 1-methylimidazolium methanesulfonate, 1,3-dimethylimidazolium methanesulfonate, 1-ethylimidazolium methanesulfonate, 1-ethyl-3-methylimidazolium methanesulfonate, 1-ethyl-2,3-dimethylimidazolium methanesulfonate, 1,3-diethylimidazolium methanesulfonate, 1-butylimidazolium methanesulfonate, 1-butyl-3-methylimidazolium methanesulfonate, 1-butyl-2,3-dimethylimidazolium methanesulfonate, 1,3-dibutylimidazolium methanesulfonate, 1-methylimidazolium acetate, 1,3-dimethylimidazolium acetate, 1-ethylimidazolium acetate, 1-ethyl-3-methylimidazolium acetate, 1-ethyl-2,3-dimethylimidazolium acetate, 1,3-diethylimidazolium acetate, 1-butylimidazolium acetate, 1-butyl-3-methylimidazolium acetate, 1-butyl-2,3-dimethylimidazolium acetate, 1,3-dibutylimidazolium acetate, 1,3-dimethylimidazolium methylcarbonate, 1-ethyl-3-methylimidazolium methylcarbonate, 1-ethyl-2,3-dimethylimidazolium acetate, 1-butyl-3-methylimidazolium methylcarbonate and 1-butyl-2,3-dimethylimidazolium methylcarbonate.

The at least one ionic liquid (IL) is very particularly preferably selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-diethylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate.

The reaction mixture (R_{G}) preferably comprises at least 50% by weight component (c), based on the total weight of the reaction mixture (R_{G}). The reaction mixture (R_{G}) particularly preferably comprises at least 64% by weight and very particularly preferably at least 70% by weight component (c), based on the total weight of the reaction mixture (R_{G}).

Furthermore, the reaction mixture (R_{G}) preferably comprises at most 90% by weight component (c), based on the total weight of the reaction mixture (R_{G}). The reaction mixture (R_{G}) particularly preferably comprises at most 84% by weight and very particularly preferably at most 80% by weight component (c), based on the total weight of the reaction mixture (R_{G}). The total weight of all components in the reaction mixture (R_{G}) generally adds up to 100% by weight.

The reaction mixture (R_{G}) preferably comprises 50 to 90% by weight component (c), based on the total weight of the reaction mixture (R_{G}). The reaction mixture (R_{G}) particularly preferably comprises 64 to 84% by weight and very particularly preferably 70 to 80% by weight component (c), based on the total weight of the reaction mixture (R_{G}).

In one embodiment, component (c) comprises at least 80% by weight, preferably at least 90% by weight and particularly preferably at least 98% by weight of at least one ionic liquid (IL) selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate, based on the total weight of component (c) in the reaction mixture (R_{G}).

In a further preferred embodiment, component (c) consists essentially of at least one ionic liquid (IL) selected from the group consisting of 1-methylimidazolium chloride, 1-ethylimidazolium chloride, 1-ethyl-3-methylimidazolium chloride, 1-butylimidazolium chloride, 1-butyl-3-methylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, 1,3-dibutylimidazolium tetrachloroaluminate.

In the context of the present invention, the expression “consists essentially of” is understood to mean that component (c) comprises at least 99% by weight of an ionic liquid (IL), based on the total weight of component (c) in the reaction mixture (R_{G}).

Preferred and particularly preferred reaction mixtures (R_{G}) result from a combination of the respective preferred components (a), (b) and (c) or the respective particularly preferred components (a), (b) and (c), as described herein. Examples of particularly preferred reaction mixtures (R_{G}) are presented in the following table, in which for component (b) the corresponding dihydrochlorides are co-disclosed:

| Component (a) | Component (b) | Component (c) |
|---|---|---|
| Terephthaloyl | 4,6-Diamino-1,3- | 1-Butyl-3-methylimidazolium |
| dichloride | dihydroxybenzene | chloride |
| Terephthaloyl | 4,6-Diamino-1,3- | 1-Ethyl-3- |
| dichloride | dihydroxybenzene | methylimidazolium chloride |
| Terephthaloyl | 4,6-Diamino-1,3- | 1,3- |
| dichloride | dihydroxybenzene | Diethylimidazolium chloride |
| Terephthaloyl | 4,6-Diamino-1,3- | 1-Methylimidazolium |
| dichloride | dihydroxybenzene | chloride |
| Terephthaloyl | 2,5-Diamino-1,4- | 1-Butyl-3- |
| dichloride | dihydroxybenzene | methylimidazolium chloride |
| Terephthaloyl | 2,5-Diamino-1,4- | 1-Ethyl-3- |
| dichloride | dihydroxybenzene | methylimidazolium chloride |
| Terephthaloyl | 2,5-Diamino-1,4- | 1,3- |
| dichloride | dihydroxybenzene | Diethylimidazolium chloride |
| Terephthaloyl | 2,5-Diamino-1,4- | 1-Methylimidazolium |
| dichloride | dihydroxybenzene | chloride |
| Terephthalic | 4,6-Diamino-1,3- | 1-Butyl-3- |
| anhydride | dihydroxybenzene | methylimidazolium chloride |
| Terephthalic | 4,6-Diamino-1,3- | 1-Ethyl-3-methylimidazolium |
| anhydride | dihydroxybenzene | chloride |
| Terephthalic | 4,6-Diamino-1,3- | 1,3-Diethylimidazolium |
| anhydride | dihydroxybenzene | chloride |
| Terephthalic | 4,6-Diamino-1,3- | 1-Methylimidazolium |
| anhydride | dihydroxybenzene | chloride |
| Terephthalic | 2,5-Diamino-1,4- | 1-Butyl-3-methylimidazolium |
| anhydride | dihydroxybenzene | chloride |
| Terephthalic | 2,5-Diamino-1,4- | 1-Ethyl-3-methylimidazolium |
| anhydride | dihydroxybenzene | chloride |
| Terephthalic | 2,5-Diamino-1,4- | 1,3-Diethylimidazolium |
| anhydride | dihydroxybenzene | chloride |
| Terephthalic | 2,5-Diamino-1,4- | 1-Methylimidazolium |
| anhydride | dihydroxybenzene | chloride |
| Isophthaloyl | 4,6-Diamino-1,3- | 1-Butyl-3-methylimidazolium |
| dichloride | dihydroxybenzene | chloride |
| Isophthaloyl | 4,6-Diamino-1,3- | 1-Ethyl-3-methylimidazolium |
| dichloride | dihydroxybenzene | chloride |
| Isophthaloyl | 4,6-Diamino-1,3- | 1,3-Diethylimidazolium |
| dichloride | dihydroxybenzene | chloride |
| Isophthaloyl | 4,6-Diamino-1,3- | 1-Methylimidazolium |
| dichloride | dihydroxybenzene | chloride |
| Isophthaloyl | 2,5-Diamino-1,4- | 1-Butyl-3-methylimidazolium |
| dichloride | dihydroxybenzene | chloride |
| Isophthaloyl | 2,5-Diamino-1,4- | 1-Ethyl-3-methylimidazolium |
| dichloride | dihydroxybenzene | chloride |
| Isophthaloyl | 2,5-Diamino-1,4- | 1,3-Diethylimidazolium |
| dichloride | dihydroxybenzene | chloride |
| Isophthaloyl | 2,5-Diamino-1,4- | 1-Methylimidazolium |
| dichloride | dihydroxybenzene | chloride |
| Isophthalic | 4,6-Diamino-1,3- | 1-Butyl-3-methylimidazolium |
| anhydride | dihydroxybenzene | chloride |
| Isophthalic | 4,6-Diamino-1,3- | 1-Ethyl-3-methylimidazolium |
| anhydride | dihydroxybenzene | chloride |
| Isophthalic | 4,6-Diamino-1,3- | 1,3-Diethylimidazolium |
| anhydride | dihydroxybenzene | chloride |
| Isophthalic | 4,6-Diamino-1,3- | 1-Methylimidazolium |
| anhydride | dihydroxybenzene | chloride |
| Isophthalic | 2,5-Diamino-1,4- | 1-Butyl-3-methylimidazolium |
| anhydride | dihydroxybenzene | chloride |
| Isophthalic | 2,5-Diamino-1,4- | 1-Ethyl-3-methylimidazolium |
| anhydride | dihydroxybenzene | chloride |
| Isophthalic | 2,5-Diamino-1,4- | 1,3-Diethylimidazolium |
| anhydride | dihydroxybenzene | chloride |
| Isophthalic | 2,5-Diamino-1,4- | 1-Methylimidazolium |
| anhydride | dihydroxybenzene | chloride |

The reaction mixture (R_{G}) is reacted at a temperature in the range of 0 to 120° C., preferably in the range of 35 to 100° C. and particularly preferably in the range of 70 to 80° C. to give the product mixture (P_{VG}), which comprises the aramid. Optionally, volatile reaction products formed in this reaction, for example halohydrocarbons such as hydrogen chloride, are preferably removed from the reaction space, for example by negative pressure and/or purging the reaction space and/or the reaction mixture (R_{G}) with an inert gas, i.e. a gas which does not participate in the reaction under the conditions described, for example nitrogen or a noble gas such as argon or optionally by adding a base as described above.

The reaction of the reaction mixture (R_{G}) to give the product mixture (P_{VG}) can be carried out in the customary apparatus of chemical engineering, such as stirred tanks, screw machines, for example extruders.

The reaction of the reaction mixture (R_{G}) to give the product mixture (P_{VG}) can be carried out batchwise or continuously.

The components (a) and (b) that form the reaction mixture (R_{G}) are generally added as such (in the sense of undiluted), usually individually and sequentially, to component (c).

In a particularly suitable variant of the reaction of the reaction mixture (R_{G}) to give the product mixture (P_{VG}), components (c) and (b) are initially charged, preferably while stirring, and component (a) is added to this mixture, preferably in portions, in the desired amount, typically a stoichiometric amount or in slight excess, for example 0.5 mol % excess, based on component (b). If component (a) is added portionwise, the number of portions is for example 2 to 10.

The end of the reaction of the reaction mixture (Re) to give the product mixture (P_{VG}) can be recognized thereby in that the torque of the stirrer no longer increases.

The product mixture (P_{VG}) is then further processed to fibers, films or moldings and without further processing or after processing, for example by isolating the aramid, for example by precipitation, but preferably, particularly in the further processing to fibers, without further processing.

The further processing of the product mixture (P_{VG}) to fibers, films or moldings takes place at a temperature T_{V} at which practically no conversion to polybenzazole polymer (P), for example PBO, takes place. Typically, T_{V} is in the range from 0 to 100° C., preferably in the range from 20 to 60° C.

The further processing of the product mixture (PVG) to fibers is typically conducted by the method of spinning in suitable devices customary for this purpose, for example a piston spinning system, at the customary temperatures specific for the polymer. Typically, spinning is conducted vertically downwards. Suitable spinnerets are 144 hole/100 μm or 64 hole/150 μm with an L/D ratio of 3:1. The resulting pressures during spinning are highly dependent on the boundary conditions of the spinning, such as spin temperature, spinneret geometry and dimensions, typically being in the range of 60 to 100 bar. The discharge rate of the spinning composition obtained from the product mixture (PVG) is for example in the range of 1 to 2 m/min. The filament bundle typically formed is generally directed into a coagulation bath via an air gap of gap width in the range of 1 to 100 mm, for example in the range of 10 to 50 mm. This usually consists of demineralized water but can also comprise portions of component (c) (IL) used. The temperature of the coagulation bath is, for example, 20 to 30° C. and the residence time in the coagulation bath is, for example, ca. 40 s.

In a preferred embodiment, the filament bundle obtained by spinning the product mixture (PVG) is stretched by customary methods. For example, to stretch the filament bundle obtained by spinning the product mixture (PVG), this is passed from the coagulation bath to a godet by means of a deflecting roller. The rate of which typically determines the draw ratio. The stretching of the filament bundle obtained by spinning the product mixture (PVG) is, for example, in the range of 20% to 30%. In a preferred embodiment, the filament bundle obtained by spinning the product mixture (PVG) is then fed through a demineralized water bath heated to a temperature in the range of 60 to 100° C., for example heated to 88 to 90° C., typically for the removal of solvent residues or impurities.

Typically, the filament bundle obtained by spinning the product mixture (PVG) is dried at a temperature at which practically no conversion to polybenzazole polymer (P), for example PBO, takes place, for example at 120° C., for example in a hot-air channel.

The fibers, films and moldings of aramid thus obtained, preferably fibers and films of aramid, especially fibers of aramid, are converted by heating to a temperature in the range of 250 to 500° C., preferably in the range of 300 to 450° C. to fibers, films and moldings of polybenzazole polymer (P), for example PBO.

For example, the fibers of aramid thus obtained are converted to fibers of polybenzazole polymer (P), for example PBO, by heating to a temperature in the range of 250 to 500° C., preferably in the range of 300 to 450° C. and in each case preferably by stretching. In a further particularly suitable embodiment, the fibers of aramid are produced with the maximum possible stretching. A person skilled in the art knows that the stretching is dependent on many spinning parameters, for example the spinning temperature, and is difficult to quantify. For example, “maximum possible stretching” is understood to mean here the point at which exceeding this results in relatively frequent tearing during the spinning process.

Fibers, films and moldings of polybenzazole polymer (P), for example PBO, are produced by the method according to the invention.

The present invention therefore also further relates to fibers, films and moldings of polybenzazole polymer (P), for example PBO, which are produced by the method according to the invention.

The polybenzazole polymer (P) preferably has repeating units of the general formula (XIIa), (XIIb), (XIIc), (XIId), (XIIe) and/or (XIIf):

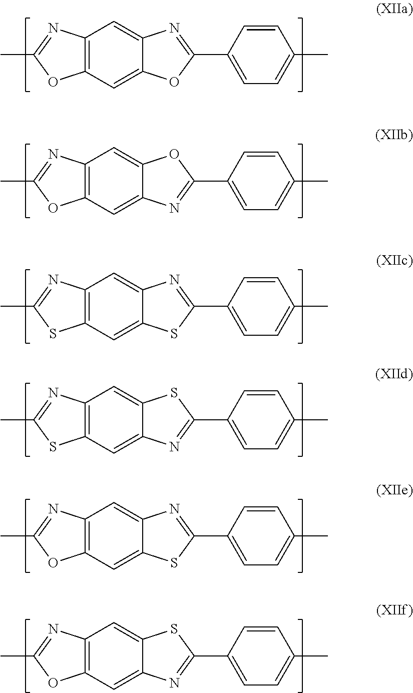

In a preferred embodiment, the polybenzazole polymer (P) comprises at least 40% by weight, preferably at least 60% by weight and particularly preferably at least 80% by weight of repeating units selected from the group consisting of repeating units of the general formulae (XIIa), (XIIb), (XIIc), (XIId), (XIIe) and (XIIf), based on the total weight of the polybenzazole polymer (P).

In a particularly preferred embodiment, the polybenzazole polymer (P) comprises at least 40% by weight, preferably at least 60% by weight and particularly preferably at least 80% by weight of repeating units selected from the group consisting of repeating units of the general formulae (XIIa) and (XIIb).

The weight data specified here with respect to the repeating units of the general formulae (XIIa), (XIIb), (XIIc), (XIId), (XIIe) and (XIIf) refer here to the total weight of repeating units of the general formula (XIIa), (XIIb), (XIIc), (XIId), (XIIe) and (XIIf).

In a further particularly preferred embodiment, the polybenzazole polymer (P) consists essentially of repeating units selected from the group consisting of repeating units of the general formulae (XIIa) and (XIIb). In the context of the present invention, the expression “consists essentially of” is understood to mean that the polybenzazole polymer (P) comprises at least 95% by weight, preferably at least 97% by weight and particularly preferably at least 99% by weight of repeating units selected from the group consisting of repeating units of the general formulae (XIIa) and (XIIb), based on the total weight of the polybenzazole polymer (P).

In a further particularly preferred embodiment, the polybenzazole polymer (P) consists of repeating units selected from the group consisting of repeating units of the general formulae (XIIa), i.e. PBO, and (XIIb), i.e. trans-PBO.

The polybenzazole polymer (P) is particularly preferably poly(p-phenylene-2,6-benzobisoxazole), i.e. PBO.

The polybenzazole polymer (P) obtained by the method according to the invention, for example PBO, generally has a viscosity number from 3 to 40 dl/g, preferably from 10 to 35 dl/g and particularly preferably from 15 to 30 dl/g. The viscosity number is determined in accordance with DIN EN ISO 1628-1 at 25° C. in methanesulfonic acid.

The fibers, films or moldings of polybenzazole polymer (P) according to the invention, for example PBO, comprise practically no sulfur or phosphorus, for example in the form of sulfur-containing or phosphorus-containing acids. In this context, “practically no” typically signifies an amount below the detection limit of elemental analysis, for example for phosphorus of less than 100 ppm by weight, as determined by the method described in the examples.

Relevant sulfur-containing or phosphorus-containing acids are generally known to those skilled in the art and comprise in particular phosphoric acid, polyphosphoric acid, sulfuric acid, methanesulfonic acid, trifluoromethanesulfonic acid and chlorosulfonic acid.

The fibers, films and moldings of polybenzazole polymer (P), for example PBO, produced by the method according to the invention, can be used in many sectors, for example (i) fibers for producing cables, ropes, cords, for sheathing glass fibers, for producing fiber-reinforced rubber materials, for example vehicle tyres and conveyor belts, for producing fiber-reinforced building materials, for example continuous fibers or short cut fibers in cement or concrete, for example spray concrete, for producing brake linings for disk brakes, for producing nonwoven materials, for example non-wovens for gas filtration, for producing textiles, for example for bullet-proof vests, temperature-resistant protective clothing, layers in helmets, for supply cable sheaths, for textile-reinforced building materials, for example as textile concrete for restoration and repair of buildings, (ii) films in thermally stable membranes for gas separation, in proton-conducting membranes, in electrooptic devices or light emitting diodes, (iii) moldings as high temperature-resistant polymeric materials.

### EXAMPLES

The following methods were used to determine the following parameters:

Tensile strength and elastic modulus of fibers in accordance with DIN EN ISO 5079. Viscosity number in accordance with DIN EN ISO 1628-1 at 25° C. in methanesulfonic acid.

Phosphorus determination (method MB 2018/05, BASF SE, Kompetenzzentrum Analytik) as described in the following:

Portions of the phosphorus-containing sample of 0.2 to 0.3 g are solubilized at 320° C. with conc. sulfuric acid (ca. 96% by weight H₂SO₄), concentrated nitric acid (ca. 65% by weight HNO₃) and cesium sulfate solution (50 g of cesium sulfate Cs₂SO₄ (purity 99.9) are dissolved with water to a volume of 1000 ml). The residue obtained is treated with mixed acid (conc. nitric acid+conc. perchloric acid (ca. 70% by weight HClO₄)+conc. sulfuric acid in a ratio by volume of 2:1:1) at ca. 160° C. The excess acids are evaporated and the residue is boiled and dissolved with 25% by volume hydrochloric acid (mixture of conc. hydrochloric acid (ca. 36% by weight HCl)+water in a ratio by volume of 3:1) and deionized water. The precise volume is determined via back weighing and calculation of the density.

In the resulting digested solution, phosphorus is measured by atomic emission spectrometry (ICP-OES).

Matrix digestion solution and standards: c(HCl) ca. 0.6 mol/L, ca. 0.2% (m/v) Cs₂SO₄.

Instrument: ICP-OES Agilent 5100 spectrometer.

Measurement conditions: integration time 10 sec, generator 1200 W, conical nebulizer 1 ml, spectral line (nm): P 213.618; corrections: Sc 361.383 nm (internal standard), calibration: external.

### 1. General Experimental Method for Producing the Product Mixture (P_{VG})

A 750 ml double-jacketed glass reactor equipped with an anchor stirrer and distillation head was filled with 1-butyl-3-methylimidazolium chloride (“BMIM-Cl”). The ionic liquid (IL) was dried at 130° C. while stirring (100 rpm) under nitrogen feed (60 L/h) and reduced pressure (50 mbar absolute pressure) until a water content of <0.03% was achieved (measurement by Karl-Fischer titration of an aliquot withdrawn). After temperature-conditioning of the IL at 75° C., 4,6-diaminoresorcinol dihydrochloride (IUPAC name 4,6-diamino-1,3-dihydroxybenzene dihydrochloride) (“DAR”) was added and stirred overnight until a homogeneous solution was obtained (ca. 16 h). Subsequently, terephthaloyl dichloride (“TC”) was added in five portions as a solid while stirring (100 rpm), wherein there were ca. 15 min between successive metered additions. The total metered addition amount of these five metered additions were 50, 75, 88, 95, 98 mol % TC based on the amount of DAR used. Reaction gases were discharged by means of a nitrogen stream (ca. 90 L/h) at negative pressure (ca. 50 mbar absolute pressure). After the fifth metered addition of the appropriate TC amount (see above), the torque of the stirrer increased slowly until a torque of ca. 80 Ncm was reached, whereupon the stirring speed was then reduced (to ca. 20 rpm). If the torque did not further increase, further TC was added (total amount of the six metered additions therefore corresponded to 100.1 to 100.6 mol % with respect to the amount of DAR), as a result of which the torque rapidly increased. The stirring speed was further reduced (ca. 10 rpm) and the mixture was stirred further until there was no further torque increase. Finally, the mixture was kept at reduced pressure (ca. 50 mbar) without further stirring in order to reduce the amount of gas inclusions in the solution, whereby further processing (for example spinning) is generally facilitated. After releasing the reaction vessel to standard pressure (ca. 1013 mbar), an aliquot of the solution was withdrawn for rheological characterization (see characterization).

### Examples V1 to V3

TABLE 1.1

| | | Amount of | | | | | | | | |
|---|---|---|---|---|---|---|---|---|---|---|
| | | BMIM-Cl | | | | | | | Excess | |
| | | | | H₂O | Amount of | | Amount of | | TC to | |
| | T | | | in IL | DAR | | TSC | | DAR | |
| V No. | [° C.] | [g] | [mmol] | [%] | [g] | [mmol] | [g] | [mmol] | (mol %) | Additive |
| 1 | 75 | 351.09 | 2010 | 0.024 | 45.970 | 215.76 | 44.023 | 216.84 | 0.581 | — |
| 2 | 75 | 204.85 | 1173 | 0.026 | 26.822 | 125.89 | 25.558 | 125.89 | 0.090 | 3 mol % |
| | | | | | | | | | | LiCl/DAR |
| 3 | 75 | 309.08 | 1770 | 0.026 | 40.469 | 189.94 | 38.755 | 190.89 | 0.585 | |

### Characterization

The polymer solutions were characterized rheologically on a DHR type rheometer from TA Instruments, Newcastle (USA) by frequency sweeps at constant temperature in each case. The frequencies were spaced logarithmically equidistant between 250 and 1 rad/s recording 10 points per decade. The temperature was varied stepwise between 10° C. and 60° C. in steps of 10K. A lower Peltier plate with nitrogen-flushed covering composed of acrylic glass served as temperature-control system to avoid condensation (necessarily required in view of the hygroscopic properties of the IL used). The upper plate had a diameter of 25 mm at a slit width of 1 mm. The deformation imposed was consistently 10%.

From the results of the 6 isothermal frequency experiments for each solution, a master curve was generated at a reference temperature of 20° C. The horizontal shift factors a_{T} were fitted to the WLF equation according to Malcolm L. Williams, Robert F. Landel and John D. Ferry The Temperature Dependence of Relaxation Mechanisms in Amorphous Polymers and Other Glass-forming Liquids, Journal of the American Chemical Society, 1955.

$${log}_{10} {a}_{T} = \frac{- {c}_{1} ( T - {T}_{ref} )}{{c}_{2} + T - {T}_{ref}} .$$

For the vertical shift factors b_{T} only the temperature was taken into consideration

$${b}_{T} = \frac{{T}_{ref}}{T} ,$$

where all temperatures here are to be specified in Kelvin.

The following solutions were evaluated as suitable for spinning in which the correlation between the loss factor tan(b) and the value of the complex viscosity |η*| at any desired but fixed frequency in a certain process window was (tan(δ)/|η*|˜1, at 0.1 rad/s, where |η*|=45 000-90 000 Pa*s). This process window was determined empirically.

2. Spin Tests with PVG:

A piston spinning system from Fourné served as spinning apparatus. Prior to the actual spinning test, the spinning solution in the spinning piston was made as gas bubble-free as possible.

The filled piston was installed in the piston spinning system and heated to the spinning temperature, see Table 2.1. As nozzles, either a 144 hole 100 μm nozzle or a 64 hole 150 μm nozzle with an L/D ratio of 3/1 was used. It was spun vertically downwards. The pressures formed here were highly dependent on the temperature, the solution concentration, the piston feed rate and the nozzle to be used. Generally, they were 60 to 100 bar. The discharge rate of the spinning composition was 1 to 2 m/min. The filament bundle thus formed was passed to a coagulation bath of demineralized water at a temperature of ca. 25° C. across an air gap (distance of nozzle to edge of coagulation bath) of 10 to 100 mm. The filament bundle was passed from the bath to a godet by means of a deflecting roller. The rate of which determines the draw ratio. Stable spinning tests could be achieved at a stretching of 20% and 30%. Spinning tests with 50% stretching and more resulted in relatively frequent torn filaments in the fiber bundle. The residence time in the coagulation bath was ca. 40 s.

For washing, the fiber bundle was fed through a demineralized water bath heated to 88 to 90° C. The residence time here was ca. 32 s. In this case the fiber was stretched by 20% via a godet. The fiber was then fed by means of a godet through hot air channel at 120 for drying. The residence time in the drying process was ca. 34 s. From the latter godet, the fiber thus formed was spooled with a tension-controlled winder from Qeriklon-Barmag (Wuff 6e) with a pre-tension force of 100 cN. The results are listed in Table 2.1 below. The V No. 1, 2 3 herein signifies the batches stated in Table 1.1, and the corresponding spinning tests A, B, C result in samples 1A, 1B, 1C, 2A and 3A, which were used in the condensations as presented in 3.1 and 3.2.

TABLE 2.1

| Spinning solution | Unit | V No. 1 | | | V No. 2 | V No. 3 |
|---|---|---|---|---|---|---|
| Additive | [mol %] | 14.3 | | | 15 mol % | 14.3 |
| | | | | | LiCl | |
| Viscosity at 0.1 rad/s | [(Pa · s)] | 49556 | | | 86867 | 70960 |
| tan delta at 0.1 rad/s | — | 1.109 | | | 0.989 | 0.982 |
| Spinning tests | — | A | B | C | A | A |
| Nozzle diameter | [μm] | 150 | 150 | 150 | 150 | 150 |
| Temperature | [° C.] | 50 | 52 | 53 | 25 | 66 |
| Length of air gap | [mm] | 100 | 100 | 100 | 100 | 100 |
| Stretching nozzle | [%] | 80 | 30 | 40 | 30 | 23 |
| Stretching bath | [%] | — | — | — | 15 | 17 |
| Total stretching | [%] | 80 | 30 | 40 | 50 | 44 |
| Filament tearing | — | yes | no | no | no | no |
| Fiber properties | | | | | | |
| Elongation at break | [%] | 47 | 53 | 50 | 32 | 56 |
| Tensile strength | [cN/tex] | 16.4 | 14.5 | 14.8 | 13.6 | 13.2 |
| Tensile strength | [GPa] | 0.16 | 0.15 | 0.15 | 0.14 | 0.13 |
| Fineness | [dtex] | 15.0 | 19.6 | 18.1 | 20.0 | 11.0 |
| Elastic modulus | [cN/tex] | 492 | 456 | 465 | 426 | 475 |
| Elastic modulus | [GPa] | 4.9 | 4.6 | 4.7 | 4.3 | 4.8 |

### 3.1 PBO Condensation No. 1:

The fibers obtained from the spinning tests were fed through an oven purged with nitrogen at 42000 (oven length 3 m, 8 heating zones). The stretching of the material was achieved by a thread tensioner in the unwinding unit. Here, a defined rolling resistance was predetermined.

At the oven outlet, the thread was guided via a godet to a tension-controlled winder. Stable stretchings were 20 to 30%; at higher stretchings there was partial filament tearing. The residence times in this process were ca. 60 min. The tests and results are summarized in Table 3.1.1.

TABLE 3.1.1

| | | 1B- | 1B- | 1C- | 2A- | 2A- | 2A- | 2A- |
|---|---|---|---|---|---|---|---|---|
| T | | K1 | K2 | K1 | K1 | K2 | K3 | K4 |
| Residence time at | [min] | ~60 | ~60 | ~60 | 53 | 56 | 58 | 59 |
| T = 420° C. | | | | | | | | |
| Stretching | [%] | 15 | 30 | 32 | 14 | 28 | 38 | 46 |
| Filament tearing | | no | no | no | no | no | yes | yes |
| Elongation at | [%] | 1.8 | 1.3 | 1.1 | 1.6 | 1 | 0.8 | 0.8 |
| break | | | | | | | | |
| Tensile strength | [cN/tex] | 33.2 | 35.3 | 37.3 | 31.2 | 34.3 | 40.9 | 42.3 |
| Tensile strength | [GPa] | 0.50 | 0.53 | 0.56 | 0.47 | 0.51 | 0.61 | 0.63 |
| Fineness | [dtex] | 11.36 | 11.35 | 9.54 | 11.57 | 10.43 | 9.88 | 9.95 |
| Elastic modulus | [cN/tex] | 2754 | 3515 | 4181 | 2691 | 4006 | 5568 | 5716 |
| Elastic modulus | [GPa] | 41 | 53 | 63 | 40 | 60 | 84 | 86 |

Herein, tests with the different aramid fibers 1B, 1C and 2A according to the invention are presented in which in each case the stretching was varied, except 1C-K1. It can be seen from Table 3.1.1 that the elastic modulus and tensile strength of the aramid fiber according to the invention increase markedly after condensation, columns with the headings 1B-K1, 1B-K2 and columns 2A-K1 to 2A-K4.

Moreover, it can be seen that when a higher stretching was applied already during the production of the aramid fiber according to the invention (compare column 1B and 1C in Table 2.1, line “Total stretching”), this has an advantageous effect on the properties (for example elastic modulus, tensile strength) of the fibers of PBO which were obtained at comparable stretchings during conversion of aramid fiber to fiber of PBO, compare Table 3.1.1 1B-K2 with 1C-K1.

### 3.2 PBO Condensation No. 2:

In these tests, the residence time was shortened from ca. 60 min to ca. 10 min. The fibers were fed through an oven (oven length 3 m, 6 heating zones) purged with inert gas (N₂), in which the following heating program (HP) was used:

| | HP1 | HP2 | HP3 |
|---|---|---|---|
| T (° C.) Zone 1 | 420 | 280 | 320 |
| T (° C.) Zone 2 | 420 | 320 | 360 |
| T (° C.) Zone 3 | 420 | 360 | 420 |
| T (° C.) Zone 4 | 420 | 400 | 420 |
| T (° C.) Zone 5 | 420 | 420 | 420 |
| T (° C.) Zone 6 | 420 | 420 | 420 |

The residence time per heating zone was ⅙ of the total residence time which can be seen from the following table. Stretching of the material was accomplished by the speed difference of two godets (1× oven inlet, 1× oven outlet). The PBO fiber obtained was spooled with a tension-controlled winder. Stable stretchings were 20 to 30%; at higher stretchings there was partial filament tearing. The tests and results are summarized in Table 3.2.1 and 3.2.2.

TABLE 3.2.1

| | | | 3A- | 3A- | 3A- | 3A- | 3A- | 3A- |
|---|---|---|---|---|---|---|---|---|
| | | 3A | K1 | K2 | K3 | K4 | K5 | K6 |
| Heating program | | — | HP1 | HP1 | HP1 | HP1 | HP2 | HP2 |
| Total residence time | [min] | — | 54.2 | 36.8 | 27.3 | 13.6 | 54.6 | 27.3 |
| Stretching | [%] | 44 | 20 | 20 | 20 | 20 | 20 | 20 |
| Elongation at break | [%] | 56 | 2.6 | 2.4 | 2 | 2.1 | 3.3 | 2.6 |
| Tensile strength | [cN/tex] | 12.3 | 36.2 | 34.7 | 34.5 | 33.3 | 34.1 | 31.6 |
| Tensile strength | [GPa] | 0.18 | 0.54 | 0.52 | 0.52 | 0.50 | 0.51 | 0.47 |
| Fineness | [dtex] | 11.01 | 6.34 | 6.67 | 6.1 | 6.43 | 6.96 | 6.73 |
| Elastic modulus | [cN/tex] | 475 | 2626 | 2594 | 2774 | 2703 | 2237 | 2270 |
| Elastic modulus | [GPa] | 7 | 39 | 39 | 42 | 41 | 34 | 34 |

Presented herein are tests 3A-K1 to 3A-K6 in which, for example, the heating program (HP1, HP2) and/or the total residence time were varied and the stretching was not varied. It can be seen from Table 3.2.1 that, for example, the elastic modulus and tensile strength of the aramid fiber according to the invention (column with heading 3A) increase markedly after condensation, columns with the headings 3A-K1 to 3A-K6.

TABLE 3.2.2

| | | 3A- | 3A- | 3A- | 3A- | 3A- | 3A- | 3A- |
|---|---|---|---|---|---|---|---|---|
| | | K7 | K8 | K9 | K10 | K11 | K12 | K13 |
| Heating program | | HP2 | HP2 | HP2 | HP2 | HP3 | HP3 | HP3 |
| Total residence time | [min] | 28.1 | 28.7 | 14.3 | 14.6 | 10.9 | 8.2 | 8.7 |
| Stretching | [%] | 28 | 35 | 35 | 40 | 20 | 20 | 38 |
| Elongation at break | [%] | 2.4 | 1.4 | 1.3 | 1.3 | 1.7 | 1.7 | 1.1 |
| Tensile strength | [cN/tex] | 34.4 | 38 | 41.9 | 42.5 | 33.7 | 32.4 | 42.7 |
| Tensile strength | [GPa] | 0.52 | 0.57 | 0.63 | 0.64 | 0.51 | 0.49 | 0.64 |
| Fineness | [dtex] | 6.66 | 5.92 | 5.34 | 5.19 | 6.35 | 6.24 | 5.26 |
| Elastic modulus | [cN/tex] | 2686 | 3767 | 4285 | 4491 | 2909 | 2855 | 4777 |
| Elastic modulus | [GPa] | 40 | 57 | 64 | 67 | 44 | 43 | 72 |

Presented herein are tests 3A-K7 to 3A-K13 in which, for example, the heating program (HP1, HP2) and/or the total residence time were varied and the stretching was additionally varied. It can be seen from Table 3.2.2 that, by higher stretching, for example the elastic modulus and tensile strength of the aramid fiber according to the invention (column with heading 3A) increase further after condensation, columns with the headings 3A-K7 to 3A-K13.

### 4. Investigations on the Stability of the PBO Fiber to Hydrolysis and Aqueous Alkali.

### 4.1 Hydrolysis

The hydrolysis of a fiber of PBO according to the invention, namely 1B-K2 of Table 3.1.1, was carried out according to the conditions described in the following, as listed in the technical data sheet of the commercial PBO fiber Zylon® (PBO Fiber Zylon Technical Information, 2005, 1-18.). The fibers of PBO according to the invention were stored at 80° C. and 80% relative air humidity and the tensile strength determined after various time intervals in accordance with DIN EN ISO 5079. No significant deterioration in tensile strength could be detected after 50 days treatment; compare Table 4.1.1. In comparison thereto, the PBO fiber Zylon® AS loses ca. 30% tensile strength after 50 days according to the information in the previously mentioned technical data sheet of Toyobo.

TABLE 4.1.1

| Tensile strength [cN/tex] | After x days |
|---|---|
| 35.3 | 0 (initial value) |
| 34.3 | 10 |
| 34 | 23 |
| 34 | 50 |

### 4.2 Stability to Alkali

The stability to alkali of a PBO fiber according to the invention, namely 1B-K2 of Table 3.1.1, was carried out according to the conditions described in the following, as listed in the technical data sheet of the commercial PBO fiber Zylon® (PBO Fiber Zylon Technical Information, 2005, 1-18.). The fibers of PBO according to the invention were stored at 80° C. in aqueous alkali (10% by weight NaOH) and the tensile strength was determined after 100 h. Whereas the loss of tensile strength of the fibers of PBO according to the invention was only ca. 8% of the initial strength, the PBO fiber Zylon® AS loses ca. 70% of the original tensile strength according to the information in the previously mentioned technical data sheet of Toyobo.

### 4.3 Stability to UV

The stability to UV of a PBO fiber according to the invention, namely 1B-K2 of Table 3.1.1, was carried out according to the conditions described in the following, as listed in a similar design also in the technical data sheet of the commercial PBO fiber Zylon® (PBO Fiber Zylon Technical Information, 2005, 1-18.). The fibers of PBO according to the invention were exposed in a xenon laboratory weathering device to the conditions below and the tensile strength was determined after 168 h. Lamp type: Xenon 320, dose rate 42 W/m², temperature: 30° C., relative air humidity: 60%. Whereas the loss of tensile strength of the fibers of PBO according to the invention was only ca. 9% of the initial strength, the PBO fiber Zylon® AS loses ca. 75% of the original tensile strength.

1. A method for producing a film, fiber, or molding including a polybenzazole polymer, the method comprising
reacting a reaction mixture at a first temperature in a range of from 0 to 120° C. to obtain a product mixture;
processing the product mixture to give a film, fiber, or molding at a second temperature in a range of from 0 to 100° C., to obtain a processed film, fiber, or molding; and
heating of the processed film, fiber, or molding at a third temperature in a range of from 250 to 500° C.,
wherein the reaction mixture comprises:
(a) an aromatic dicarboxylic compound of formula (I): 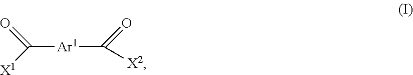
wherein
Ar¹ is an optionally substituted phenylene, naphthalenediyl, anthracenediyl, biphenyldiyl, diphenylmethanediyl, diphenyl ether diyl, diphenyl thio ether diyl, diphenyl sulfone diyl, benzophenonediyl, pyridinediyl, pyrimidinediyl, furandiyl, or thiophenediyl, substituents being —F, —Cl, —Br, —OR¹, or —C₁-C₁₀-alkyl, and R¹ being —H or —C₁-C₁₀-alkyl,
X¹ and X² are independently OR², —F, —Cl, or —Br,
R² being —H, —C₁-C₁₀-alkyl, —C₁-C₁₀-alkenyl, or a repeating unit of formula (Ia): 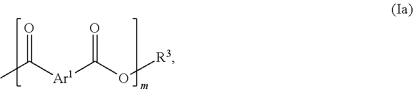
wherein
m is a natural number from 1 to 50, and
R³ is —H, —C₁-C₁₀-alkyl, or —C₁-C₁₀-alkenyl;
(b) an aromatic diamino compound of formula (IIa), (IIb), (IIc), and/or (IId): 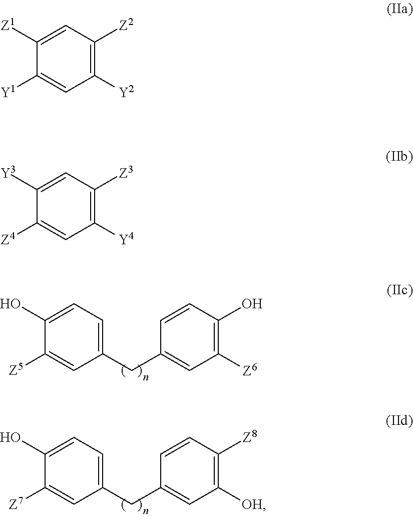
wherein
n is 0 or 1
Y¹, Y², Y³, and Y⁴ are independently —H, —OR⁴, or —SR⁴, R⁴ being —H, —C₁-C₁₀-alkyl, trimethylsilyl, tert-butyldimethylsilyl, acetyl, or tert-butyloxycarbonyl,
wherein at most one of Y¹ and Y² is —H, and
wherein at most one of Y³ and Y⁴ is —H;
Z¹, Z², Z³, Z⁴, Z⁵, Z⁶, Z⁷, and Z⁸ are independently —NH₂ or —NH₃⁺Q⁻, Q⁻ is F⁻, Cl⁻, Br⁻, I⁻, HSO₄⁻, SO₄²⁻, H₃C—SO₃⁻, p-H₃C—C₆H₄—SO₃⁻, or NO₃⁻; and
(c) an ionic liquid.

2. The method of claim 1, wherein Ar¹ is 1,3-phenylene, 1,4-phenylene, naphthalene-1,4-diyl, naphthalene-2,6-diyl, anthracene-2,6-diyl, anthracene-9,10-diyl, biphenyl-4,4′-diyl, diphenylmethane-4,4′-diyl, diphenyl ether 4,4′-diyl, diphenyl thioether 4,4′-diyl, diphenyl sulfone 4,4′-diyl, benzophenone-4,4′-diyl, pyridine-2,5-diyl, pyrimidine-4,6-diyl, or furan-2,5-diyl and thiophene-2,5-diyl.

3. The method of claim 1, wherein the aromatic dicarboxylic compound (a) is terephthalic acid, terephthalic anhydride, terephthaloyl difluoride, terephthaloyl dichloride, terephthaloyl dibromide, C₁-C₁₀-alkyl esters of terephthalic acid, C₁-C₁₀-alkenyl esters of terephthalic acid, isophthalic acid, isophthalic anhydride, isophthaloyl difluoride, isophthaloyl dichloride, isophthaloyl dibromide, polyanhydrides of isophthalic acid, C₁-C₁₀-alkyl esters of isophthalic acid, and/or C₁-C₁₀-alkenyl esters of isophthalic acid.

4. The method of claim 1, wherein the aromatic diamino compound (b) is 4,6-diamino-1,3-dihydroxybenzene, 4,6-diamino-1,3-dihydroxybenzene dihydrochloride, 2,5-diamino-1,4-dihydroxybenzene, and/or 2,5-diamino-1,4-dihydroxybenzene dihydrochloride.

5. The method of claim 1, wherein the reaction mixture comprises, based on total reaction mixture weight,
5 to 25 wt. % of the aromatic dicarboxylic compound (a),
5 to 25 wt. % of the aromatic diamino compound (b), and
50 to 90 wt. % of the ionic liquid (c).

6. The method of claim 1, wherein the ionic liquid is of formula (III):
[C]ₙ⁺[A]ⁿ⁻ (III),
wherein
n is 1, 2, 3, or 4,
[C]ₙ⁺ is a cation including optionally substituted imidazolium, imidazolinium, imidazolidinium, quaternary ammonium, quaternary phosphonium, pyrazolium, pyrazolinium, pyridinium, pyridazinium, pyrimidinium, pyrazinium, pyrrolidinium, guanidinium, thiazolium, oxazolium, triazolium, 1,8-diazabicyclo[5.4.0]undec-7-enium, and/or 1,8-diazabicyclo[4.3.0]non-5-enium, enium, and/or an oligomer and/or polymer comprising any of these cations, substituents being C₁-C₁₈-alkyl, —C₅-C₁₂-cycloalkyl, and/or —C₆-C₁₄-aryl,
[A]ⁿ⁻ is a halide comprising anion, cyanide, thiocyanate, cyanate, isocyanate, nitrite, nitrate, sulfate, sulfite, sulfonate, carboxylate, borate, boronate, carbonate, carbonate ester, amide, carboximidate, sulfonyl imidate, bis(sulfonyl) imidate, alkoxide, or aryl oxide, optionally comprising a substituent, the substituent being C₁-C₁₈-alkyl, —C₅-C₁₂-cycloalkyl and/or —C₆-C₄-aryl.

7. The method of claim 6, wherein the ionic liquid comprises an imidazolium cation of formula (IV) as [C]ₙ⁺: 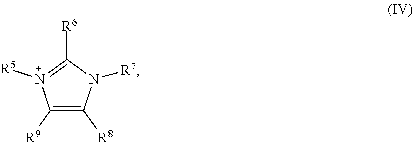
wherein
R⁵, R⁶, R⁷, R⁸, and R⁹ are independently —H, C₁-C₁₈-alkyl, —C₅-C₁₂-cycloalkyl, or —C₆-C₁₄-aryl.

8. The method of claim 6, wherein [C]ₙ⁺ is 1-methylimidazolium, 1-methyl-2-ethylimidazolium, 1-methyl-3-octylimidazolium, 1,2-dimethylimidazolium, 1,3-dimethylimidazolium, 2,3-dimethylimidazolium, 3,4-dimethylimidazolium, 1,2,3-trimethylimidazolium, 1,3,4-trimethylimidazolium, 1,3,4,5-tetramethylimidazolium, 1-ethylimidazolium, 1-ethyl-2-methylimidazolium, 1-ethyl-3-methylimidazolium, 1-ethyl-2,3-dimethylimidazolium, 2-ethyl-3,4-dimethylimidazolium, 1-propylimidazolium, 1-propyl-2-methylimidazolium, 1-propyl-3-methylimidazolium, 1-propyl-2,3-dimethylimidazolium, 1,3-dipropylimidazolium, 1-butylimidazolium, 1-butyl-2-methylimidazolium, 1-butyl-3-methylimidazolium, 1-butyl-4-methylimidazolium, 1-butyl-2,3-dimethylimidazolium, 1-butyl-3,4-dimethylimidazolium, 1-butyl-3,4,5-trimethylimidazolium, 1-butyl-2-ethylimidazolium, 1-butyl-3-ethyl-imidazolium, 1-butyl-2-ethyl-5-methylimidazolium, 1,3-dibutylimidazolium, 1,3-dibutyl-2-methylimidazolium, 1-pentylimidazolium, 1-pentyl-2-methylimidazolium, 1-pentyl-3-methylimidazolium, 1-pentyl-2,3-dimethylimidazolium, 1-hexylimidazolium, 1-hexyl-2-methylimidazolium, 1-hexyl-3-methylimidazolium, 1-hexyl-2,3-dimethylimidazolium, 1-octyl-2-methylimidazolium, 1-octyl-3-methylimidazolium, 1-decyl-3-methylimidazolium, 1-dodecyl-3-methylimidazolium, 1-tetradecyl-3-methylimidazolium, 1-hexadecyl-3-methylimidazolium, and/or 1-benzyl-3-methylimidazolium.

9. The method of claim 1, wherein the ionic liquid is 1-methylimidazolium chloride, 1-ethylimidazolium chloride, 1-ethyl-3-methylimidazolium chloride, 1-butylimidazolium chloride, 1-butyl-3-methylimidazolium chloride, 1,3-diethylimidazolium chloride, 1,3-dibutylimidazolium chloride, 1-methylimidazolium tetrachloroaluminate, 1-ethylimidazolium tetrachloroaluminate, 1-ethyl-3-methylimidazolium tetrachloroaluminate, 1,3-diethylimidazolium tetrachloroaluminate, 1-butylimidazolium tetrachloroaluminate, 1-butyl-3-methylimidazolium tetrachloroaluminate, and/or 1,3-dibutylimidazolium tetrachloroaluminate.

10. The method of claim 1, wherein the reacting of the reaction mixture is conducted in the presence of a basic compound comprising trialkylamine, imidazole, pyridine, lithium hydroxide, sodium hydroxide, potassium hydroxide, magnesium hydroxide, calcium hydroxide, barium hydroxide, lithium carbonate, sodium carbonate, potassium carbonate, magnesium carbonate, calcium carbonate, lithium hydride, sodium hydride, potassium hydride, magnesium hydride, and/or calcium hydride.

11. The method of claim 1, wherein the reaction mixture comprises the aromatic dicarboxylic compound (a), the aromatic diamino compound (b), and the ionic liquid (c) in a combination of
terephthaloyl dichloride, 4,6-diamino-1,3-dihydroxybenzene, and 1-butyl-3-methylimidazolium chloride,
terephthaloyl dichloride, 4,6-diamino-1,3-dihydroxybenzene, and 1-ethyl-3-methylimidazolium chloride,
terephthaloyl dichloride, 4,6-diamino-1,3-dihydroxybenzene, and 1,3-diethylimidazolium chloride,
terephthaloyl dichloride, 4,6-diamino-1,3-dihydroxybenzene, and 1-methylimidazolium chloride,
terephthaloyl dichloride, 2,5-diamino-1,4-dihydroxybenzene, and 1-butyl-3-methylimidazolium chloride,
terephthaloyl dichloride, 2,5-diamino-1,4-dihydroxybenzene, and 1-ethyl-3-methylimidazolium chloride,
terephthaloyl dichloride, 2,5-diamino-1,4-dihydroxybenzene, and 1,3-diethylimidazolium chloride,
terephthaloyl dichloride, 2,5-diamino-1,4-dihydroxybenzene, and 1-methylimidazolium chloride,
wherein the aromatic diamino compound (b) is optionally a corresponding dihydrochloride.

12. A fiber, film, or molding obtained by the method of claim 1.

13. A method of producing an article including a cable, rope, cord, glass fiber sheathing, fiber-reinforced rubber material, fiber-reinforced building material, brake lining suitable for disk brake, non-woven material, or textile optionally for a bullet-proof vest, temperature-resistant protective clothing, helmet layer, supply cable sheath, textile-reinforced building material, and/or textile concrete suitable for restoration or repair of building, the method comprising
carrying out the method of claim 1; and
processing the fiber, film, or molding into the article.

14. A thermally stable membrane configured for gas separation, proton-conducting membrane, electrooptic device, or light emitting diode made by a method comprising the method of claim 1.

15. A high temperature-resistant polymeric material, made by a method comprising the method of claim 1.

16. The method of claim 1, wherein the reaction mixture comprises the aromatic dicarboxylic compound (a), the aromatic diamino compound (b), and the ionic liquid (c) in a combination of
terephthalic anhydride, 4,6-diamino-1,3-dihydroxybenzene, and 1-butyl-3-methylimidazolium chloride,
terephthalic anhydride, 4,6-diamino-1,3-dihydroxybenzene, and 1-ethyl-3-methylimidazolium chloride,
terephthalic anhydride, 4,6-diamino-1,3-dihydroxybenzene, and 1,3-diethylimidazolium chloride,
terephthalic anhydride, 4,6-diamino-1,3-dihydroxybenzene, and 1-methylimidazolium chloride,
terephthalic anhydride, 2,5-diamino-1,4-dihydroxybenzene, and 1-butyl-3-methylimidazolium chloride,
terephthalic anhydride, 2,5-diamino-1,4-dihydroxybenzene, and 1-ethyl-3-methylimidazolium chloride,
terephthalic anhydride, 2,5-diamino-1,4-dihydroxybenzene, and 1,3-diethylimidazolium chloride,
terephthalic anhydride, 2,5-diamino-1,4-dihydroxybenzene, and 1-methylimidazolium chloride,
wherein the aromatic diamino compound (b) is optionally a corresponding dihydrochloride.

17. The method of claim 1, wherein the reaction mixture comprises the aromatic dicarboxylic compound (a), the aromatic diamino compound (b), and the ionic liquid (c) in a combination of
isophthaloyl dichloride, 4,6-diamino-1,3-dihydroxybenzene, and 1-butyl-3-methylimidazolium chloride,
isophthaloyl dichloride, 4,6-diamino-1,3-dihydroxybenzene, and 1-ethyl-3-methylimidazolium chloride,
isophthaloyl dichloride, 4,6-diamino-1,3-dihydroxybenzene, and 1,3-diethylimidazolium chloride,
isophthaloyl dichloride, 4,6-diamino-1,3-dihydroxybenzene, and 1-methylimidazolium chloride,
isophthaloyl dichloride, 2,5-diamino-1,4-dihydroxybenzene, and 1-butyl-3-methylimidazolium chloride,
isophthaloyl dichloride, 2,5-diamino-1,4-dihydroxybenzene, and 1-ethyl-3-methylimidazolium chloride,
isophthaloyl dichloride, 2,5-diamino-1,4-dihydroxybenzene, and 1,3-diethylimidazolium chloride,
isophthaloyl dichloride, 2,5-diamino-1,4-dihydroxybenzene, and 1-methylimidazolium chloride,
wherein the aromatic diamino compound (b) is optionally a corresponding dihydrochloride.

18. The method of claim 1, wherein the reaction mixture comprises the aromatic dicarboxylic compound (a), the aromatic diamino compound (b), and the ionic liquid (c) in a combination of
isophthalic anhydride, 4,6-diamino-1,3-dihydroxybenzene, and 1-butyl-3-methylimidazolium chloride,
isophthalic anhydride, 4,6-diamino-1,3-dihydroxybenzene, and 1-ethyl-3-methylimidazolium chloride,
isophthalic anhydride, 4,6-diamino-1,3-dihydroxybenzene, and 1,3-diethylimidazolium chloride,
isophthalic anhydride, 4,6-diamino-1,3-dihydroxybenzene, and 1-methylimidazolium chloride,
isophthalic anhydride, 2,5-diamino-1,4-dihydroxybenzene, and 1-butyl-3-methylimidazolium chloride,
isophthalic anhydride, 2,5-diamino-1,4-dihydroxybenzene, and 1-ethyl-3-methylimidazolium chloride,
isophthalic anhydride, 2,5-diamino-1,4-dihydroxybenzene, and 1,3-diethylimidazolium chloride,
isophthalic anhydride, 2,5-diamino-1,4-dihydroxybenzene, and 1-methylimidazolium chloride,
wherein the aromatic diamino compound (b) is optionally a corresponding dihydrochloride.
